(19) United States
(12) Patent Application Publication
(10) Pub. No.: US 2025/0219775 A1
(43) Pub. Date: Jul. 3, 2025

(54) SYSTEMS AND METHODS FOR PERFORMING AMBIENT-INTERNET-OF-THINGS (A-IOT) BASED COMMUNICATIONS

(71) Applicant: Samsung Electronics Co., Ltd., Suwon-si (KR)

(72) Inventors: Yaser Mohamed Mostafa Kamal FOUAD, San Diego, CA (US); Philippe Jean Marc Michel SARTORI, Naperville, IL (US)

(21) Appl. No.: 18/999,621

(22) Filed: Dec. 23, 2024

Related U.S. Application Data
(60) Provisional application No. 63/615,651, filed on Dec. 28, 2023.

(51) Int. Cl. H04L 5/00; H04W 56/00

(52) U.S. Cl. CPC H04L 5/0044; H04L 5/0048; H04W 56/001

(57) ABSTRACT

A system and a method are disclosed for performing A-IoT based communications. The method includes receiving, by an A-IoT device, an energizing signal, causing, based on the energizing signal, the A-IoT device to become activated, storing energy from the energizing signal in the A-IoT device, a duration of the energizing signal including a duration associated with activating the A-IoT device and/or a duration associated with storing the energy to satisfy a threshold amount of energy, receiving, by the A-IoT device, a first signal including a preamble, at least a portion of the preamble indicating a beginning of a payload associated with the first signal, and decoding, by the A-IoT device, at least a portion of the payload based on the preamble.

### CROSS-REFERENCE TO RELATED APPLICATION

This application claims the priority benefit under 35 U.S.C. § 119(e) of U.S. Provisional Application No. 63/615,651, filed on Dec. 28, 2023, the disclosure of which is incorporated by reference in its entirety as if fully set forth herein.

### TECHNICAL FIELD

The disclosure generally relates to communications. More particularly, the subject matter disclosed herein relates to improvements to performing Ambient-Internet-of-Things (A-IoT) based communications.

### SUMMARY

A-IoT devices may be used for a wide array of applications where other devices may not be suitable. For example, A-IoT devices may operate at a peak power consumption of less than a few thousand microwatts (μW), which is much less than, for example, a user equipment (e.g., a smart phone, laptop computer, and/or the like). Many (e.g., most) A-IoT devices can operate without batteries and may be advantageous for use in extreme environmental conditions. It may be desirable to synchronize one or more A-IoT devices with a timing scheme, associated with other devices, to coordinate receptions and transmissions of signals within a communications system, including base stations, UEs, and A-IoT devices. However, A-IoT devices may not be able to be synchronized like UEs. For example, using a sidelink synchronization signal block (S-SSB), which may be used for synchronization of UEs, may be too complicated, may include irrelevant information, and may result in too much power consumption to be suitable for processing by A-IoT devices. Additionally, a physical sidelink broadcast channel (PSBCH) may not be available for use, due to a lack of a defined broadcast channel for A-IoT communications.

To overcome these and other issues, systems and methods are described herein to provide for synchronization, energy harvesting, frequency diversity, multiplexing of synchronization and/or energizing signals, and beamforming to improve communications in systems including A-IoT devices.

In some embodiments, a synchronization signal structure may include an energizing signal and an accompanied payload.

In some embodiments, a delay may be introduced between the starting of the energizing signal and the accompanied payload to allow for energy harvesting.

In some embodiments, a preamble may be used to identify control signal boundaries within the synchronization signal.

In some embodiments, the control signal may be segmented within the synchronization signal structure with each segment being independently decoded.

In some embodiments, centralized scheduling by a gNB may be used for the synchronization-signal resources or the use of a distributed energy detection-based approach for selecting the synchronization signal resources.

In some embodiments, a time multiplexing between the energizing signal and the corresponding payload within the synchronization signal may be implemented.

In some embodiments, a modulated energizing signal may be used to carry the associated payload within the synchronization signal.

In some embodiments, padding within the modulated energizing signal may be used to allow enough time for energy harvesting and A-IoT device activation.

In some embodiments, a more advanced synchronization signal, for Type 2b A-IoT devices, including a synchronization sequence and a broadcast signal may be used.

In some embodiments, time/frequency repetitions of the synchronization signal may be used to improve reliability and detectability of the synchronization signal.

In some embodiments, beamforming for the synchronization signal may be used, wherein the beam forming parameters can be dynamically changed based on multiple pre-configured parameters.

In some embodiments, a pre-configured minimum time duration per beam may be used to allow for energy harvesting.

The above approaches may improve on previous methods because: an energizing signal within the synchronization signal may allow Type 1 and Type 2a A-IoT devices to simultaneously synchronize and perform energy harvesting; the proposed delay may allow enough time for energy harvesting, especially for Type 2a A-IoT devices with a larger on-board energy storage; A-IoT devices may be enabled to easily identify the control signal boundaries within the synchronization signal thus reducing the processing requirements; the processing burden on A-IoT devices may be reduced by allowing the low category devices (e.g., Type 1) to decode only a subset of the control segments sent by the source; the possible collisions between synchronization signals transmitted by neighboring intermediate nodes may be reduced thus improving the system performance; the A-IoT devices may be enabled to perform enough energy harvesting before attempting to decode the payload within the synchronization signal; the resource utilization efficiency may be improved by allowing the synchronization payload to be carried by the modulated energizing signal; the ability of low-end A-IoT devices (e.g., Type 2a A-IoT devices) to perform energy harvesting and collect enough energy may be increased; advanced A-IoT devices (e.g., Type 2b devices) may be enabled to have better synchronization thus improving the overall system performance; the time/frequency repetitions of the synchronization signal may allow enough time/energy for harvesting by the A-IoT devices; resource utilization may be improved and the energy harvested by the devices may be increased by using beam formed synchronization signals (including the energizing signal); and the low end A-IoT devices may be enabled to perform enough energy harvesting by allocating a minimum duration per beam.

According to some embodiments of the present disclosure, a method for performing A-IoT based communications includes receiving, by an A-IoT device, an energizing signal, causing, based on the energizing signal, the A-IoT device to become activated, storing energy from the energizing signal in the A-IoT device, a duration of the energizing signal including a duration associated with activating the A-IoT device and/or a duration associated with storing the energy to satisfy a threshold amount of energy, receiving, by the A-IoT device, a first signal including a preamble, at least a portion of the preamble indicating a beginning of a payload associated with the first signal, and decoding, by the A-IoT device, at least a portion of the payload based on the preamble.

The preamble may include a first bit sequence to synchronize the A-IoT device with a timing scheme for performing a transmission, a reception, and/or an action.

The preamble may be pre-configured, such that a source of the first signal is identifiable based on at least a portion of the preamble.

The preamble may include a sine wave to synchronize the A-IoT device with a timing scheme for performing a transmission, a reception, and/or an action.

The preamble may be received, by the A-IoT device, in a physical reader-to-device channel (PRDCH) to indicate the beginning of a coded signal.

A portion of the preamble may be pre-defined and may cause the A-IoT device to become activated.

The preamble may be predefined, such that a first preamble from a first source includes a same bit sequence as a second preamble from a second source.

A resource of the energizing signal may be scheduled by a base station through a DCI, or the resource of the energizing signal may be reserved by SCI based on UE sensing.

The energizing signal may be time multiplexed and/or frequency multiplexed from a first-source signal and a second-source signal.

The first signal may include the energizing signal.

The energizing signal may be a first energizing signal corresponding to a group of repetitions of energizing signals repeated in a time domain or in a frequency domain, and the group of repetitions may include the first energizing signal and a second energizing signal that is separated from the first energizing signal by a duration of time or by corresponding to a different frequency than the first energizing signa.

The first energizing signal may correspond to the group of repetitions of energizing signals repeated in the frequency domain, and the first energizing signal may be pre-configured, by a source, to be transmitted on an anchor frequency to provide energy to the A-IoT device.

The A-IoT device may select a second signal based on a signal strength of the first signal being less than a threshold value, the second signal may include a signal to synchronize the A-IoT device.

The method may further include detecting, by the A-IoT device, only a first segment of the payload, the first segment may be independently encoded from a remaining part of the payload.

According to other embodiments of the present disclosure, a device for performing A-IoT based communications includes a processor, and an antenna communicatively connected to the processor, wherein the antenna is configured to receive an energizing signal and a first signal, the first signal including a preamble, at least a portion of the preamble indicating a beginning of a payload associated with the first signal, and cause energy from the energizing signal to be stored in the device, a duration of the energizing signal including a duration associated with activating the processor and/or a duration associated with storing the energy to satisfy a threshold amount of energy, and the processor is configured to decode at least a portion of the payload based on the preamble.

The preamble may include a first bit sequence to synchronize the device with a timing scheme for performing a transmission, a reception, and/or an action.

The preamble may be pre-configured, such that a source of the first signal is identifiable based on at least a portion of the preamble.

The preamble may include a sine wave to synchronize the device with a timing scheme for performing a transmission, a reception, and/or an action.

The preamble may be received, by the antenna, in a physical reader-to-device channel (PRDCH) to indicate the beginning of a coded signal.

According to other embodiments of the present disclosure, a system for performing A-IoT based communications includes a processor, and a memory storing instructions, which, based on being executed by the processor, cause the processor to perform becoming activated based on energy from an energizing signal, a duration of the energizing signal including a duration associated with activating the system and/or a duration associated with storing, by the system, the energy to satisfy a threshold amount of energy, receiving a first signal including a preamble, at least a portion of the preamble indicating a beginning of a payload associated with the first signal, and decoding at least a portion of the payload based on the preamble.

### BRIEF DESCRIPTION OF THE DRAWING

In the following section, the aspects of the subject matter disclosed herein will be described with reference to exemplary embodiments illustrated in the figures.

FIG. 1 is a block diagram of a system including components for performing A-IoT based communications, according to some embodiments of the present disclosure.

FIG. 2 is a block diagram depicting a process overview for performing A-IoT based communications, according to some embodiments of the present disclosure.

FIG. 3A is a diagram depicting a first A-IoT topology, according to some embodiments of the present disclosure.

FIG. 3B is a diagram depicting a second A-IoT topology, according to some embodiments of the present disclosure.

FIG. 4 is a diagram depicting a frequency multiplexing between the energizing signal and a coded signal, according to some embodiments of the present disclosure.

FIG. 5 is a flowchart depicting example operations of a method for initiating synchronization between a source (e.g., a base station or an intermediate node) and the A-IoT device, according to some embodiments of the present disclosure.

FIG. 6 is a diagram depicting a method for scheduling an energizing signal, according to some embodiments of the present disclosure.

FIG. 7 is a diagram depicting synchronization using a preamble and a coded signal in the presence of a relatively contiguous energizing signal, the preamble preceding the slot of the coded signal, according to some embodiments of the present disclosure.

FIG. 8 is a diagram depicting synchronization using a preamble and a coded signal in the presence of a relatively contiguous energizing signal, the preamble being provided in the same slot as the coded signal, according to some embodiments of the present disclosure.

FIG. 9 is a diagram depicting a multiplexing between the energizing signal and the coded signal, according to some embodiments of the present disclosure.

FIG. 10 is a diagram depicting padding of the coded signal to allow for energy harvesting, according to some embodiments of the present disclosure.

FIG. 11 is a diagram depicting three methods (e.g., three alternatives) for handling a portion of the coded signal after the transmission of a backscattering signal from the A-IoT device, according to some embodiments of the present disclosure.

FIG. 12 is a diagram depicting a method for dividing a synchronization signal into two components to support different device categories, according to some embodiments of the present disclosure.

FIG. 13 is a diagram depicting energizing signals starting at a slot boundary (as indicated by associated coded signals), which may be used for synchronization, according to some embodiments of the present disclosure.

FIG. 14 is a diagram depicting time-domain repetitions of the energizing signal, according to some embodiments of the present disclosure.

FIG. 15 is a diagram depicting beamforming of synchronization signals, according to some embodiments of the present disclosure.

FIG. 16 is a block diagram of a first type of A-IoT device for performing operations associated with the method for performing A-IoT based communications, according to some embodiments of the present disclosure.

FIG. 17 is a block diagram of a second type of A-IoT device for performing operations associated with the method for performing A-IoT based communications, according to some embodiments of the present disclosure.

FIG. 18 is a block diagram of an electronic device (e.g., a user equipment (UE)) in a network environment, according to some embodiments of the present disclosure.

FIG. 19 is a flowchart depicting example operations of a method for performing A-IoT based communications, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/of” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Any numerical range disclosed and/or recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

A-IoT systems (also referred to as AIoT systems) may be utilized for a large spectrum of applications and may be utilized to fill a gap in communications ecosystems (e.g., in the current Third Generation Partnership Project (3GPP) ecosystem). Unlike other systems, an underlying assumption of A-IoT devices is that they are battery free in most cases and, thus, are applicable in a variety of environments (e.g., extreme environmental conditions, involving high pressure, extremely high or extremely low temperatures, and/or humidity). Although the majority of A-IoT devices may be battery free, A-IoT devices may still be capable of communicating with a base station (e.g., a gNodeB, also referred to as a gNB) and may achieve ranges up to 500 meters (e.g., for outdoor applications).

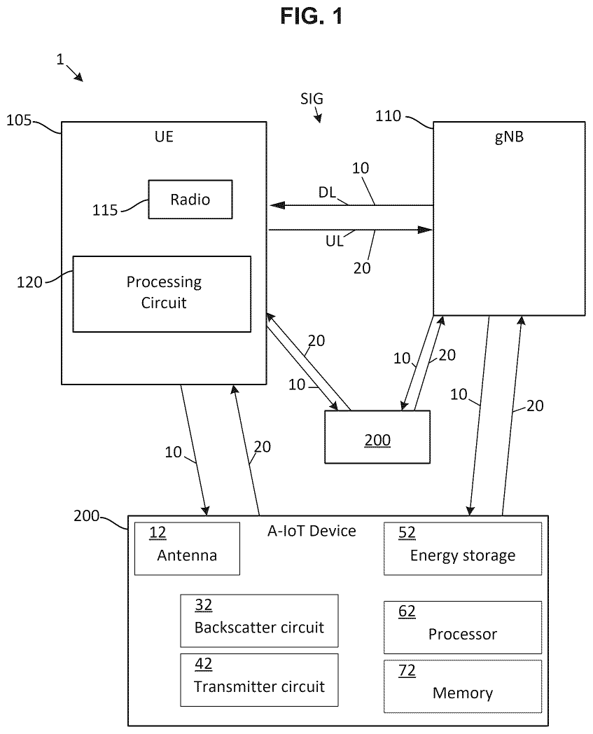

FIG. 1 is a block diagram of a system 1 including components for performing A-IoT based communications, according to some embodiments of the present disclosure.

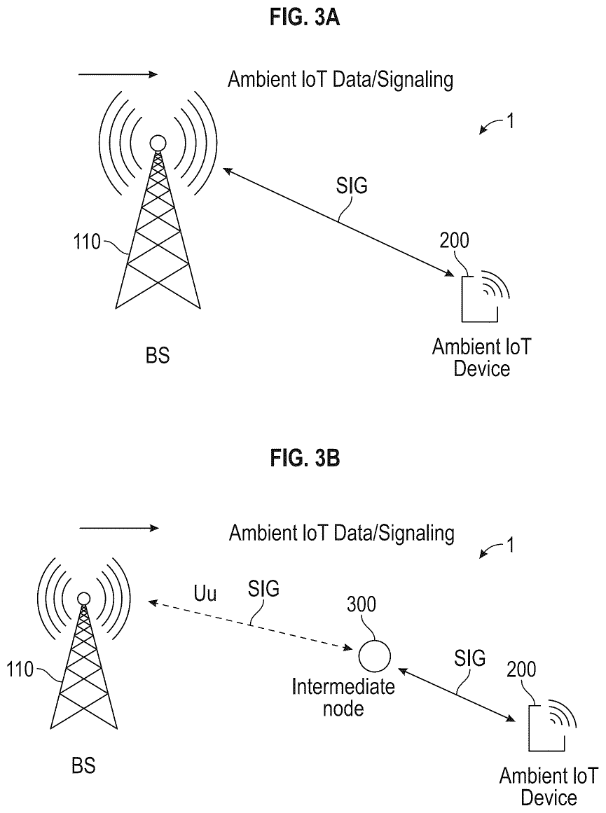

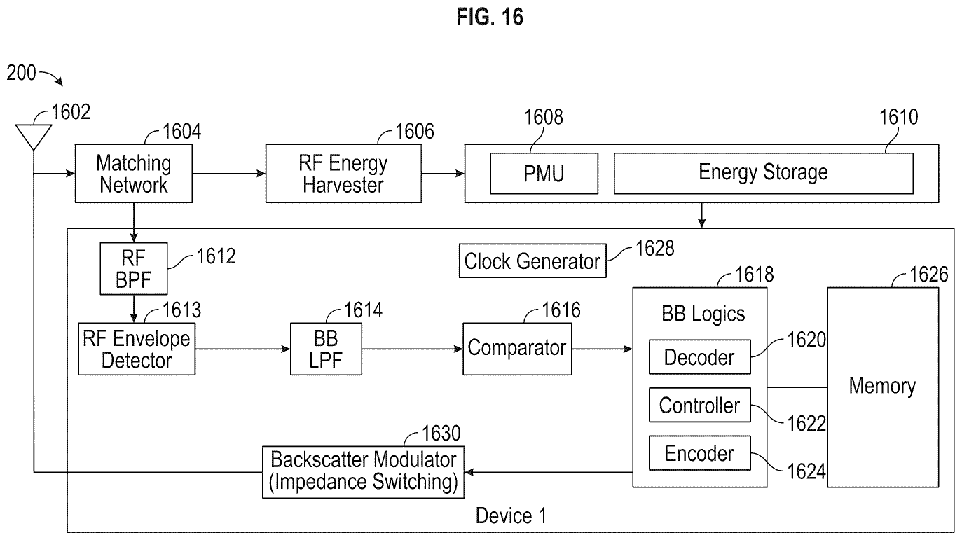

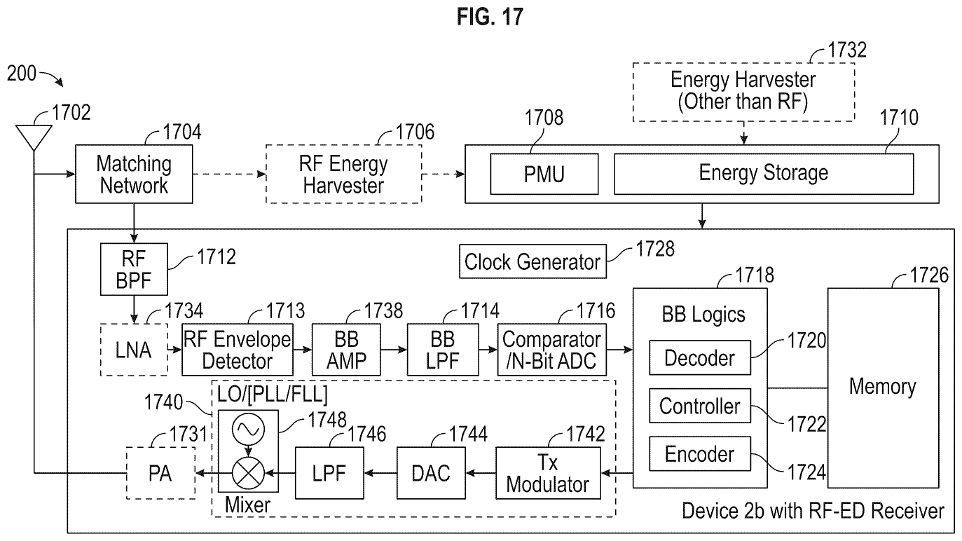

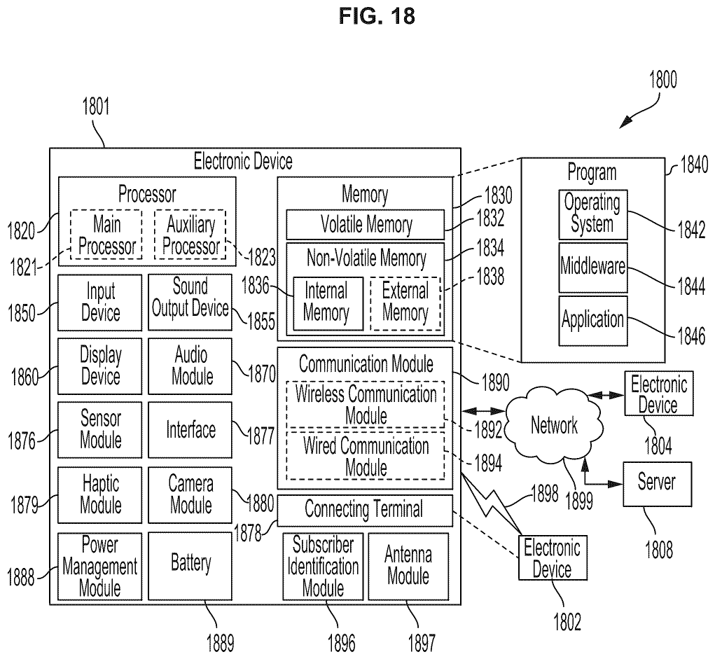

Referring to FIG. 1, the system 1 for performing A-IoT-based communications may include one or more of the following devices in communication with each other (as discussed in further detail below with reference to FIGS. 3A and 3B). In some embodiments, the system 1 may include one or more base stations 110 (e.g., one or more network nodes also referred to as gNBs), one or more UEs 105, and one or more A-IoT devices 200. In some embodiments, each of the devices may be capable of receiving downlink (DL) transmissions 10 from the other devices and may be capable of sending uplink (UL) transmissions 20 to the other devices. It should be understood that, in some embodiments, A-IoT devices 200 may not be capable of communicating directly with each other. For example, some A-IoT devices 200 may, including Type 1 and Type 2a devices may rely on backscattering to communicate with other devices. It should also be understood that UL transmissions 20 from a given A-IoT device 200 to another device are also referred to as device-to-reader (D2R) transmissions, and DL transmissions 10 from a device to a given A-IoT device 200 are also referred to as reader-to-device (R2D) transmissions. The UE 105 may include a radio 115 and a means for processing. The means for processing may include a processing circuit 120, which may perform various methods disclosed herein. The radio 115 may correspond to the communication module 1890 (see FIG. 18). The processing circuit 120 may correspond to the processor 1820 (see FIG. 18). The A-IoT devices 200 may include an antenna 12 (which may correspond to the antennas 1602 and 1702 respectively of FIG. 16 and FIG. 17), a backscatter circuit 32 (which may correspond to the backscatter modulator 1630 of FIG. 16), a transmitter circuit (which may correspond to the transmission circuit 1740 of FIG. 17), an energy storage 52 (which may correspond to the energy storages 1610 and 1710 respectively of FIG. 16 and FIG. 17), a processor 62 (may correspond to the BB logics 1618 and 1718 respectively of FIG. 16 and FIG. 17), and/or a memory 72 (which may correspond to the memories 1626 and 1726 respectively of FIG. 16 and FIG. 17).

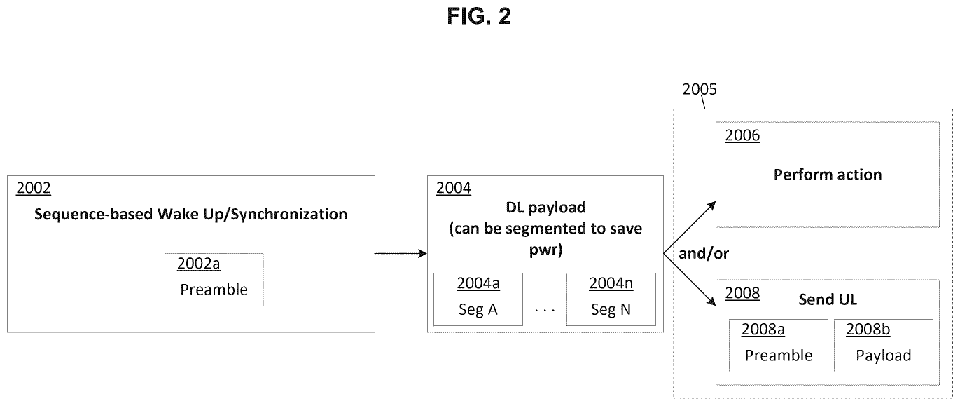

FIG. 2 is a block diagram depicting a process overview for performing A-IoT-based communications, according to some embodiments of the present disclosure.

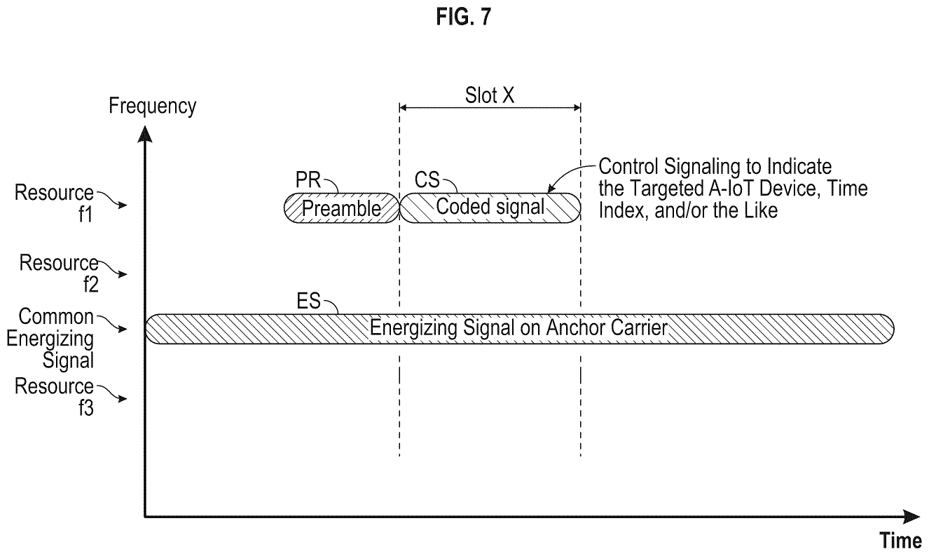

Referring to FIG. 2, A-IoT-based communications may include a sequence-based wake up/synchronization phase (operation 2002). During the sequence-based wake up/synchronization phase, a preamble 2002a may be received by the A-IoT device 200 to assist in synchronizing the A-IoT device 100. The preamble 2002a may correspond to the preamble PR of FIG. 7. In some embodiments, the A-IoT device 200 may also be awakened during operation 2002. In some embodiments, the preamble 2002a may be a part of a signal (e.g., a first signal) that also includes an energizing signal (e.g., the energizing signal ES of FIG. 7). A-IoT-based communications may include a downlink (DL) payload phase 2004, wherein a payload indicated by the preamble 2002a may be decoded by the A-IoT device 200. For example, the A-IoT device 200 may decode at least a portion of the payload comprising control signaling and/or data signaling. In some embodiments, the payload may be segmented into segments (e.g., a first segment 2004a through an n-th segment 2004n) to save power. A-IoT-based communications may include a D2R response window 2005, wherein the A-IoT device 200 may perform an action 2006 and/or send an uplink 2008. The uplink 2008 may include a preamble 2008a associated with a payload 2008b. In some embodiments, the action 2006 may include changing a setting or changing an operation performed by equipment to which the A-IoT device 200 is attached. For example, the A-IoT device 200 may cause the equipment to stop performing an operation in a manufacturing environment (based on instructions from a decoded payload segment (e.g., the first segment 2004a) and then may send the uplink 2008, in response, to indicate that the equipment has stopped performing the operation (e.g., as requested).

Example topologies with ambient IoT devices 200 are discussed in further detail below with reference to FIGS. 3A and 3B. To realize the design of A-IoT, in New Radio (NR) Release 18 (Rel-18), a study item was performed to identify the practicality of A-IoT devices. In the study item, multiple Radio Access Network (RAN) design targets were identified (e.g., device power consumption, device complexity, coverage, and/or the like). The details of the study were captured in 3GPP TR 38.848. For NR Release 19 (Rel-19), a more detailed study item was approved to further identify the ability of A-IoT devices to meet their prospective applications with a potential conversion into a work item.

Unlike conventional communication systems (e.g., NR Rel-18 sidelink), A-IoT systems might not be able to process a synchronization signal (e.g., a complicated synchronization signal) along with the broadcast channel (e.g., the synchronization signal block used by sidelink and direct links). This may be especially true for A-IoT devices, without an onboard battery, which rely on backscattering for communications. As used herein, “backscattering,” refers to sending a signal from a device based on reflecting a signal (e.g., a carrier wave) received by the device and originating from a separate source (e.g., a base station or a UE). Synchronization of A-IoT devices 200 may be used to achieve reliable communication, even if the synchronization is not highly accurate. Synchronization may allow signals from more than one (e.g., from large numbers of) A-IoT devices 200 to be multiplexed (e.g., time multiplexed and/or frequency multiplexed) and detected at a receiving node (e.g., a UE or a base station). Aspects of some embodiments of the present disclosure provide techniques and procedures (e.g., methods) to enable the synchronization of A-IoT devices 200. Aspects of some embodiments of the present disclosure provide methods for activating (e.g., for systematically activating) A-IoT devices 200, such that their signals can be detected by the receiving node.

A-IoT devices may not be expected to use battery replacement and, thus, may be desirable in applications wherein maintenance-free devices may be advantageous. For example, in some applications, A-IoT devices may be inaccessible, and it may not be possible to replace batteries in the devices. One example use case is smart bridge health monitoring. For example, multiple sensors may be embedded within a bridge structure to monitor multiple aspects of the bridge structure that are relevant to the health of the bridge structure. The sensors may report to a neighboring node (e.g., a gNB or a UE). Other example use cases include the following: 3GPP representative use case 1 (rUC1): indoor inventory, which includes 3GPP SA1 use cases/traffic scenarios: 5.1 regarding automated warehousing, 5.2 regarding medical instruments inventory management and positioning, 5.4 regarding non-public network for logistics, 5.5 automobile manufacturing, 5.7 regarding airport terminal/shipping port, 5.15 regarding smart laundry, 5.16 regarding automated supply chain distribution, 5.18 regarding fresh food supply chain, 5.27 regarding end-to-end logistics, and 6.1 regarding flower auction; rUC2: indoor sensor, which includes 3GPP SA1 use cases/traffic scenarios: 5.6 regarding smart homes, 5.13 regarding base station machine room environmental supervision, 5.15 regarding smart laundry, 5.20 regarding smart agriculture, 5.23 regarding smart pig farm, and 6.2 regarding cow stable; rUC3: indoor positioning, which includes 3GPP SA1 use cases/traffic scenarios: 5.8 regarding finding remote lost item, 5.9 regarding location service, 5.10 regarding ranging in a home, 5.12 regarding personal belongings finding, 5.14 regarding positioning in shopping centres (e.g., shopping centers), and 5.21 regarding museum guide; rUC4: indoor command, which includes 3GPP SA1 use cases/traffic scenarios: 5.11 regarding online modification of medical instruments status, 5.17 regarding device activation and deactivation, 5.26 regarding elderly health care, 5.29 regarding device permanent deactivation, and 6.3 regarding electronic shelf label; rUC5: outdoor inventory, which includes 3GPP SA1 use cases/traffic scenarios: 5.2 regarding medical instruments inventory management and positioning, 5.4 regarding non-public network for logistics, 5.7 regarding airport terminal/shipping port, and 5.16 regarding automated supply chain distribution; rUC6: outdoor sensor, which includes 3GPP SA1 use cases/traffic scenarios: 5.3 regarding smart grids, 5.19 regarding forest fire monitoring, 5.22 regarding dairy farming, 5.24 regarding smart manhole cover safety monitoring, and 5.25 regarding smart bridge health monitoring; rUC7: outdoor positioning, which includes 3GPP SA1 use cases/traffic scenarios: 5.8 regarding finding remote lost item, 5.9 regarding location service, and 5.12 regarding personal belongings finding; and rUC8: outdoor command, which includes 3GPP SA1 use cases/traffic scenarios: 5.11 regarding online modification of medical instruments status, 5.17 regarding device activation and deactivation, 5.26 regarding elderly health care, and 5.30 regarding controller in smart agriculture.

In the use cases above (e.g., rUC1 through rUC8), the A-IoT devices 200 may be less complex than narrow band IoT (NB-IoT) devices. To enable a low-complexity design (e.g., an ultra-low-complexity design), a very small device size/form factor (e.g. a thickness of millimeters (mm)), and a longer life cycle, A-IoT devices 200 for one or more of the use cases above (e.g., rUC1 through rUC8) may be designed to operate without batteries.

In A-IoT systems, a significantly large number of devices may be deployed in the field. Thus, it may be desirable for A-IoT devices 200 to be much cheaper than NB-IoT devices. Accordingly, A-IoT devices 200 may be much simpler (e.g., orders of magnitude simpler) than their NB-IoT counterparts. A-IoT devices 200 may be categorized by their energy storage capacity and their capability of generating RF signals for their transmissions. For example, three categories identified by 3GPP are as follows. Device 1 devices (also referred to as Type 1 herein) may: have no independent signal generation and/or no independent signal amplification; rely on backscattering for transmission; and have a peak power consumption of 1 μW. Device 2a devices (also referred to as Type 2a herein) may: have energy storage; have no independent signal generation; rely on backscattering for transmission; use stored energy for amplification for reflected signals (and for other purposes); and have a peak power consumption that is greater than the peak power consumption of Device 1 types of devices (e.g., hundreds of μW). Device 2b devices (also referred to as Type 2b) may: have energy storage; have independent signal generation; may have active RF components for transmission; perform backscattering (without relying solely on backscattering for transmission); and have a peak power consumption that is greater than the peak power consumption of Device 1 types of devices (e.g., hundreds of μW). The devices of categories 1, 2a, and 2b, may be able to demodulate (e.g., decode or extract) control information and data from the relevant entity (e.g., from the relevant source entity) in RAN (e.g., a UE or a gNB) according to the underlying topology.

One of ordinary skill in the art would understand that an A-IoT device (also referred to as a “tag”) is a much less complex device than a UE (e.g., see FIGS. 16-18). For example, the peak power consumption of a UE may be much greater than the peak power consumption of an A-IoT device. For example, a UE may have a peak power consumption of a few Watts (W) and may support more features (e.g., more complex features) that consume more power, such as display screens, ability to execute a variety of applications, and/or the like. As used herein, an “A-IoT device” refers to a device that may operate on a peak power consumption of less than 1 W. For example, in some embodiments, an A-IoT device 200 may operate on a peak power consumption of less than 1000 μW); in some embodiments, an A-IoT device 200 may operate on a peak power consumption of less than 500 μW; in some embodiments, an A-IoT device 200 may operate on a peak power consumption of less than 10 μW; in some embodiments, an A-IoT device 200 may operate on a peak power consumption of less than 2 μW. In some embodiments, an A-IoT device 200 may operate on only power received through electromagnetic radiation, such as RF radiation or microwave radiation carrying signals received from a gNB and/or a UE.

Ambient IoT devices 200 may operate in different environments (e.g., outdoor environments and indoor environments) and may support a wide range of communication distances (e.g., larger distances for outdoor and smaller distances for indoor applications). Several topologies were introduced in 3GPP to enable IoT devices 200 to communicate with the network. Two of the topologies are discussed below.

FIG. 3A is a diagram depicting a first A-IoT topology, according to some embodiments of the present disclosure.

Referring to FIG. 3A, in some embodiments, the A-IoT device 200 may communicate (e.g., may directly communicate) with the base station 110 (e.g., a base station serving as a “reader”). For example, the A-IoT device 200 and the base station 110 may communicate with each other bidirectionally without the assistance of a node (e.g., an intermediate node) between them. For example, the A-IoT device 200 may receive a signal SIG (e.g., a given DL transmission 10) from the base station 110 and may reflect the signal SIG back to the base station 110 to send a given UL transmission 20. In addition, the A-IoT device 200 may be able to receive a signal from a first base station 110 and respond to another base station 110. In some embodiments, the base station 110 may be a picocell (e.g., a small indoor base station having a maximum distance of 10 meters (m) to 20 m).

FIG. 3B is a diagram depicting a second A-IoT topology, according to some embodiments of the present disclosure.

Referring to FIG. 3B, in some embodiments, an intermediate node 300 (e.g., a relay, an integrated access/backhaul (IAB) node, a UE, a repeater, and/or the like) may be utilized to facilitate the communication between the A-IoT device 200 and the base station 110. The communication between the A-IoT device 200 and the intermediate node 300 may be bidirectional. The communication between the intermediate node 300 and the base station 110 may be bidirectional. In some embodiments, the base station 110 may be a microcell (e.g., a larger outdoor base station having a maximum distance greater than the maximum distance of a picocell). In some embodiments, the intermediate node 300 may collect data from one or more A-IoT devices 200 and may push (e.g., may send) the data to the base station 110. In some embodiments, the intermediate node 300 may collect data from the base station 110 and may push the data to one or more A-IoT devices 200. In some embodiments, the base station 110 and the intermediate node 300 may communicate with each other via signals SIG sent via a unique-user (Uu) interface.

As discussed above, A-IoT devices 200 operate at relatively low power (e.g., compared to UEs) and may have a relatively limited ability (if any ability) to store energy. For this reason, A-IoT devices 200 may harvest (e.g., may collect, accumulate, or store) energy from an energizing signal. That is, a given A-IoT device 200 may receive an energizing signal and store energy at the given A-IoT device 200 based on the energizing signal. In addition, A-IoT devices 200 may synchronize to be able to correctly transmit and receive from their source (e.g., from a given base station 110 or a given intermediate node 300). As used herein, “to synchronize” refers to aligning a device (e.g., an A-IoT device 200) with a timing scheme for performing a transmission and/or a reception of a signal. For example, the timing scheme may be associated with resource slots that are shared with and/or provided by one or more other devices of a communications system. Because A-IoT devices 200 may have limited capabilities and may operate at a low duty cycle, the A-IoT devices 200 may be in a sleep mode at a given time (e.g., may be in the sleep mode more often than in an active mode). Aspects of embodiments of the present disclosure provide systems and methods for performing: wake up of A-IoT devices 200 (e.g., causing the A-IoT devices 200 to become activated); energizing A-IoT devices 200; synchronization of A-IoT devices 200; and wake up of one or more neighboring A-IoT devices 200.

Aspects of some embodiments of the present disclosure provide solutions (e.g., different solutions) to address aspects of synchronization, aspects of device energization, and aspects of control signaling from the source to the neighboring A-IoT devices 200. For example, two approaches for synchronization signal design are discussed below. In some embodiments, an energizing signal may be utilized for A-IoT-device wake up and synchronization. In some embodiments, a preamble may be utilized for synchronization and wake up. For example, the preamble may wake up the A-IoT device 200 in addition to assisting with other functions such as synchronization. In some embodiments, the preamble may be followed by a control payload (including content and applications) from the source (e.g., the base station 110 or from the intermediate node 300) to the A-IoT devices 200.

Aspects of some embodiments of the present disclosure provide techniques (e.g., methods) for scheduling resources used for synchronization-signal transmission because a synchronization signal may have a low duty cycle and might not be present at all instances. For example, two approaches for resource scheduling are discussed below. In some embodiments, the resources may be scheduled by the base station 110. In some embodiments, the resources may be scheduled by the intermediate node 300 (e.g., by a UE) through sensing and resource selections.

Aspects of some embodiments of the present disclosure provide techniques for time multiplexing and/or frequency multiplexing of the energizing signal and the synchronization signal to support different A-IoT device types.

Aspects of some embodiments of the present disclosure provide improvements to the reliability and reachability of the synchronization signal by utilizing time repetitions and/or frequency repetitions, with or without beamforming of the synchronization signal.

Because devices of Type 1 and Type 2a do not have batteries, they may be energized by a signal (e.g., an RF signal). The signal may be referred to as the energizing signal. The energizing signal may be sent whenever the A-IoT device 200 is to perform communication tasks (whether transmission or reception or for internal processing). In some embodiments, devices of Type 2b may also rely, at least, in part (e.g., somewhat) on an RF signal to harvest energy.

In some embodiments, the energizing signal may be used (e.g., reused) for synchronization purposes. For example, because, when trying to reach an A-IoT device 200, the base station 110 or the intermediate node 300 (e.g., a source UE) may provide an energizing signal, the energizing signal may act as (e.g., simultaneously act as) both the wake-up signal and the energizing signal. Because the energizing signal may not be A-IoT-device-specific, and because one energizing signal may energize multiple devices, the wake-up signal may carry some payload to indicate (e.g., a portion of the payload may indicate) which A-IoT devices 200 to wake up. In addition, because, in at least some embodiments, the energizing signal may be a pure sine wave (e.g., a sine wave that is free from modulations), some synchronization information may be included with the energizing signal as well. In some embodiments, the energizing signal may carry information directly modulated in the energizing signal. In some embodiments, the energizing signal may be multiplexed with another channel (e.g., another signal) carrying the synchronization information. As discussed in further detail below, in some embodiments, a synchronization signal may include two parts: (i) a first part may include the energizing signal; and (ii) a second part may include a coded payload comprising the other synchronization information, including a slot number, a UE and/or A-IoT-device identity (e.g., an identifier of a specific UE and/or of a specific A-IoT device 200), and/or the like.

In some embodiments, the design of the energizing signal may be dependent on the targeted type of the A-IoT device 200. For example, for devices of Type 1, which rely only on backscattering with little-to-no ability to save power or to perform complex processing, devices of Type 1 may be active for only the duration of the energizing signal. In some embodiments, a given A-IoT device 200 may not be capable of amplifying the received signal (e.g., the received energizing signal) and, thus, the full round trip may be considered for determining (e.g., for taking into account) a coupling loss associated with the energizing signal. On the other hand, devices of Type 2a may be able to save power on an onboard source (e.g., a capacitor) and, thus, may be able to amplify the reflected signal (e.g., may be able to amplify the received energizing signal as when reflecting it) or may be able to perform more complex processing tasks (e.g., operations) in the absence of the energizing signal.

The present disclosure provides three approaches for the design of the energizing signal. When embedding the energizing signal into the synchronization signal, in some embodiments, the energizing signal may be either time multiplexed or frequency multiplexed with the payload. In some embodiments, the energizing signal may be modulated by the payload itself.

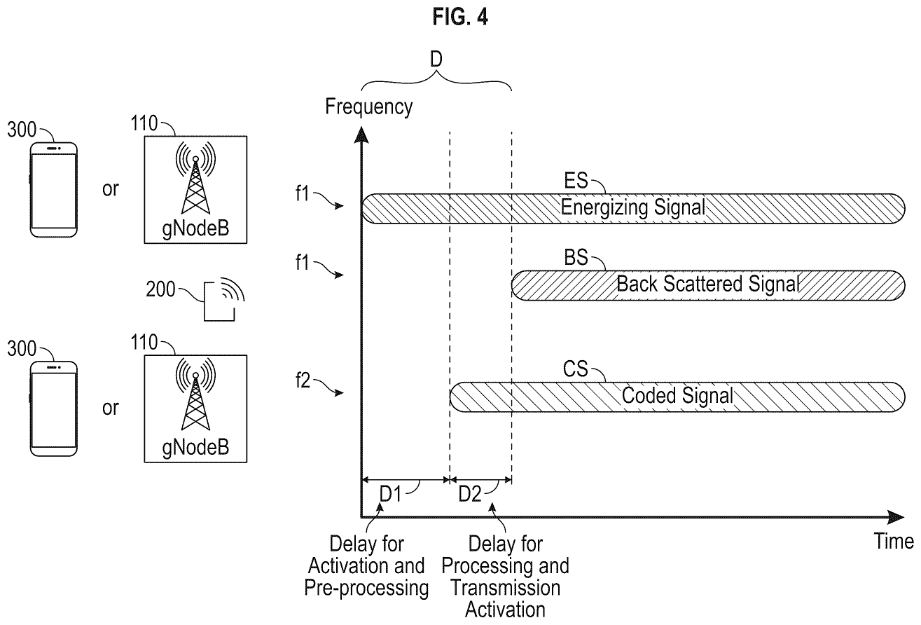

FIG. 4 is a diagram depicting a frequency multiplexing between the energizing signal ES and a coded signal CS, according to some embodiments of the present disclosure.

Referring to FIG. 4, in some embodiments, when the energizing signal ES is frequency multiplexed, the energizing signal ES (e.g., a non-modulated energizing signal) may be considered as (e.g., implemented as) a carrier frequency (e.g., frequency f1) (e.g., as a pure carrier frequency) that is sent in parallel with the coded signal CS (e.g., with the payload) on a different carrier frequency (e.g., frequency f2). In some embodiments, even an energizing signal ES that is a pure sine wave may include encoded information. For example, in some embodiments, ON-OFF-keying (OOK) or amplitude-shift keying (ASK) may be utilized to encode the energizing signal ES with information. For example, the A-IoT device 200 may encode the information by switching between absorption and reflection of the energizing signal ES (e.g., to provide the backscattered signal BS).

In some embodiments, three signals may be provided in relation to synchronization of a given A-IoT device 200. For example, in some embodiments, the energizing signal ES may be provided, by the base station 110 or by the intermediate node 300, on frequency f1 to activate the A-IoT device 200. In some embodiments, the coded signal CS may be sent, by the base station 110 or by the intermediate node 300, to carry control information and data to the A-IoT device 200 for synchronization purposes on frequency f2. The coded signal CS may be provided only for device synchronization and/or wake-up purposes only. In some embodiments, the backscattered signal BS may be sent, by the A-IoT device 200, to carry a response from the A-IoT device 200. In some embodiments, the backscattered signal BS may be provided on the same carrier frequency (e.g., frequency f1) of the energizing signal ES, without up/down conversion.

The source of the energizing signal ES may be either the base station 110 or a neighboring UE (e.g., acting as the intermediate node 300), depending on the underlying topology. In addition, the source of the energizing signal ES and the receiver of the reflected signal (e.g., of the backscattered signal BS) may not be the same as the source for the coded signal CS carrying the control information and data to activate the A-IoT device 200. In some embodiments, the coded signal CS may not be used for actual data transmission but may instead be used for control signaling related to synchronization and device wake-up.

In some embodiments, the base station 110 (e.g., a gNB) or the intermediate node 300 (e.g., a UE) may transmit a wake-up signal to activate a neighboring A-IoT device 200. In such embodiments, the wake-up signal may include the energizing signal ES and the coded signal CS (e.g., a coded payload) that is frequency multiplexed with the energizing signal.

To receive the coded signal CS (e.g., a combined wake-up/synchronization signal), the A-IoT device 200 may perform some form of synchronization. In some embodiments, synchronization may be performed based on the energizing signal ES and based on practical limitations of devices of Type 1 and Type 2a. For example, in some embodiments, a transmission-duration delay D may be provided for the total transmission duration of the energizing signal ES, the total transmission duration including all delays. That is, the transmission-duration delay D may refer to a delay that contributes to the duration of the energizing signal ES (e.g., that contributes to increasing the duration of the energizing signal ES). For example, a duration of the energizing signal ES may include a portion of the energizing signal ES (e.g., a duration that is a portion of the total duration of the energizing signal ES) that is associated with activating (e.g., activation of) the A-IoT device 200 and/or a portion of the energizing signal ES (e.g., a duration that is a portion of the total duration of the energizing signal ES) that is associated with storing enough energy from the energizing signal ES to satisfy a threshold amount of energy (e.g., a threshold amount of energy for the A-IoT device 200 to wake up, to perform energy harvesting, and/or to be able to perform one or more operations). The transmission-duration delay D of the energizing signal ES may include a first delay D1 for activation and pre-processing and a second delay D2 for processing and transmission activation. For example, once the A-IoT device 200 receives the energizing signal ES, the A-IoT device 200 may utilize the transmission-duration delay D to activate its circuits, harvest power, and perform on-board pre-processing. Because devices of Type 2a may charge their on-board power source and because devices of Type 1 may not charge an on-board power source, the duration of the transmission-duration delay D may depend on the category (e.g., the device type) of the targeted A-IoT device 200 and may be configured (e.g., may be pre-configured) per resource pool or by design.

In some embodiments, the duration of the transmission-duration delay D may be dependent on (e.g., may be determined based on) one or more other factors including the following. In some embodiments, the transmission-duration delay D may be determined based on a target transmission range. For example, a Type 2a device may save more power, than other device types, to perform an amplification of the backscattered signal BS and to reach a longer distance. In some embodiments, the transmission-duration delay D may be determined based on a suitable latency. For example, if a fast response is suitable, the delay may be reduced to provide a timely response. A fast response may be helpful, for example, when a targeted number of A-IoT devices 200 is large. For example, some A-IoT applications may include thousands of targeted A-IoT devices. In some embodiments, the transmission-duration delay D may be determined based on a measured signal strength at the source (e.g., at the base station 110 or at the intermediate node 300). For example, in some embodiments, the amount of energy harvested from the energizing signal ES may depend on the received signal strength. In such embodiments, the transmission-duration delay D may depend on a distance between the source and the A-IoT device 200. For example, the base station 110 may have multiple thresholds based on the previously received signals from the A-IoT device 200 and may decide on the duration of the energizing signal ES based on the previously received signals. In such embodiments, the multiple thresholds may be configured (e.g., may be pre-configured) per resource pool, such that the base station 110 (or other source) may determine a future duration of the energizing signal ES to preserve power and to reduce the latency. This approach may also depend on a number of acknowledgments/negative acknowledgments (ACK/NACKs) or correctly received transmissions in a reference duration. For example, the source of the energizing signal ES may start with a maximum delay for the energizing signal ES and then accordingly reduce the latency based on measurements of the reflected signal (e.g., the backscattered signal BS). In some embodiments, the transmission-duration delay D may be determined based on the source type (e.g., a gNB might have higher power and thus may have a greater signal strength than a UE).

In some embodiments, the transmission-duration delay D may be determined based on feedback from the A-IoT device 200. For example, a duration of a delay for energy harvesting may also be based on the feedback received from the A-IoT device 200. For example, the A-IoT device 200 itself in its backscattering signal BS may also provide a request to increase or decrease the duration of the delay based on its own measurements. In some embodiments, the transmission-duration delay D may be determined based on device implementation (e.g., some A-IoT devices 200 may be able to activate with a shorter delay). For example, power may be wasted if the energizing signal ES is provided for a longer duration than is suitable for a given A-IoT device 200 to activate. To overcome this issue, in some embodiments, the energizing signal ES may be configured (e.g., may be pre-configured) for a longer duration and may be stopped by the source once the backscattered signal BS is activated (e.g., correctly activated). In such embodiments, the recipient of the backscattered signal BS may be coordinated with the source of the energizing signal ES.

In some embodiments, the transmission-duration delay D may be determined based on a priority of the targeted A-IoT device 200. In such embodiments, several A-IoT devices 200 may have different priority levels. For example, in a medical facility, A-IoT devices 200 attached to medical equipment may have higher priority for their transmissions than A-IoT devices 200 attached to office equipment, for example, when performing an inventory check. The A-IoT devices 200 having a higher priority may have less of a delay than the A-IoT devices 200 having a lower priority, such that the higher priority A-IoT devices 200 may become active before the lower priority A-IoT devices.

In some embodiments, the duration of the energizing signal ES may be configured (e.g., pre-configured) to be longer than an accompanying coded payload (e.g., longer than the coded signal CS) to allow for activation and/or processing delays at the A-IoT device 200 and to allow for energy harvesting at the A-IoT device 200.

In summary, the duration of the delays incorporated within the energizing signal ES may depend on one or more factors including: the device type of the targeted A-IoT device 200; feedback from the A-IoT device 200; the target transmission range (e.g., the transmission range of the targeted A-IoT device 200); the latency (e.g., a suitable latency of the targeted A-IoT device 200); and the measured signal strength at the source; and the priority of a transmission of the A-IoT device 200.

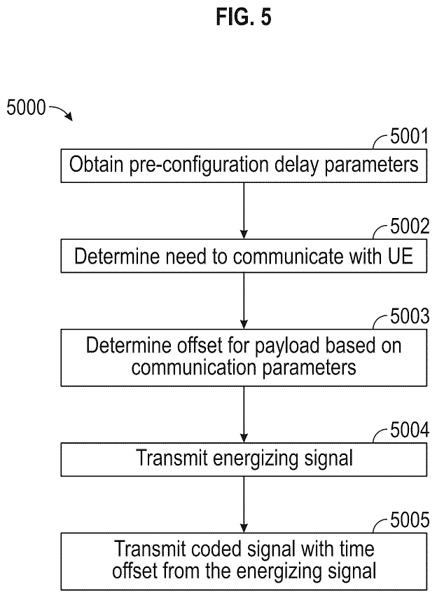

FIG. 5 is a flowchart depicting example operations of a method 5000 for initiating synchronization between a source (e.g., the base station 110 or the intermediate node 300) and the A-IoT device 200, according to some embodiments of the present disclosure.

Referring to FIG. 5, a method for initiating synchronization may include one or more of the following operations. The source (e.g., the base station 110 or the intermediate node 300) may obtain a configuration of parameters related to the delay (e.g., related to the transmission-duration delay D) (operation 5001). In some embodiments, the configuration may be configured (e.g., pre-configured) by radio resource control (RRC) signaling. In some embodiments, the configuration may be hardcoded in the source. In some embodiments, the configuration may be provided in one or more lookup tables stored at the source. For example, a given delay may be provided based on a communication range, based on a device category (e.g., a device type), or based on an underlying topology. For example, a given A-IoT device 200 of Type 2a may use more energy to charge the on-board energy storage than a given A-IoT device 200 of Type 1. In addition, a given A-IoT device 200 that is closer to the source may be able to harvest more energy from the RF signal (e.g., the energizing signal ES) than a given A-IoT device 200 that is further from the source, due to the higher signal strength closer to the source.

The source may determine whether it is suitable to communicate with another A-IoT device 200 (operation 5002). Based on the information to transmit, based on the desired range, and based on the delay parameters (obtained at operation 5001), the source may determine an offset (e.g., a time offset) between the beginning of the energizing signal ES and the coded payload (e.g., the coded signal CS). The source may then start transmitting the energizing signal ES (operation 5004). In some embodiments, the source of the energizing signal ES may be the same as the source of the coded payload (e.g., the coded signal CS). In some embodiments, the source of the energizing signal ES may be different from the source of the coded signal CS and, as discussed in further detail below, may be scheduled by the source of a control signal. Then, after at least a delay provided by the computed offset (e.g., the determined offset), the source may transmit the coded payload (e.g., the coded signal CS) (operation 5005). In some embodiments, the coded signal CS may be used mainly for synchronization and wake-up purposes, instead of being used for actual data transmission.

As discussed above, in some embodiments, the source of the energizing signal ES may not be the source of the control signal or the recipient of the backscattered signal BS. For example, the intermediate node 300 (e.g., a neighboring UE) may provide the energizing signal ES to the surrounding A-IoT devices 200 to save power, whereas the recipient of the backscattered signal BS may be the base station 110 (e.g., a gNB). In such embodiments, coordination may be provided between the intermediate node 300 and the base station 110. For example, one or more of the following approaches may be used to provide such coordination between the base station 110 and the intermediate node 300.

In some embodiments, the energizing signal ES may be sent in the same set of resources as the coded signal CS and can be triggered and/or scheduled by the base station 110. In some embodiments, resources of the energizing signal ES may be scheduled by DCI. For example, a DCI format (e.g., a new DCI format) may be designed and may be used by the base station 110 to provide a duration, resources (e.g., a starting time and a carrier frequency), targeted A-IoT devices 200 (e.g., identities of the targeted A-IoT devices 200), a specific direction and beamwidth (in the case of beamforming), and a periodicity. In addition, associated physical uplink control channel (PUCCH) resources may also be scheduled to carry ACK/NACK feedback to indicate the actual transmission of the activation signal (e.g., of the energizing signal ES).

In some embodiments, the energizing signal ES may be sent in a separate set of resources from the coded signal CS. The reservation of resources in the set may be either: (1) selected by the base station 110 and indicated in downlink control information (DCI); or (2) based on sensing information obtained by sensing the resources. The sensing may be as simple as listen-before-talk (LBT) sensing used in unlicensed spectrum transmissions and may be applicable only for devices of Type 2b. For example, before the transmission of the energizing signal ES, an intermediate node 300 (e.g., a UE) may sense the channel for a specific duration that is configured (e.g., pre-configured) before performing its transmission. In some embodiments, a sensing duration may depend on a previous reference duration. For example, if the intermediate node 300 (e.g., the UE) was able to successfully obtain the channel and transmit the energizing signal ES in the last X number of times within the reference duration, then the sensing duration may be decreased. In some embodiments, the value of X may be configured (e.g., pre-configured) per resource pool and may be dependent on a transmission priority.

In some embodiments, a device of Type 1 may apply sensing for the duration in which the energizing signal ES exists. For example, the A-IoT device 200 may receive the energizing signal ES in a set of resources and, once activated, may perform sensing in a different set of resources. In some embodiments, the sensing may be as simple as energy detection to identify resource occupancy.

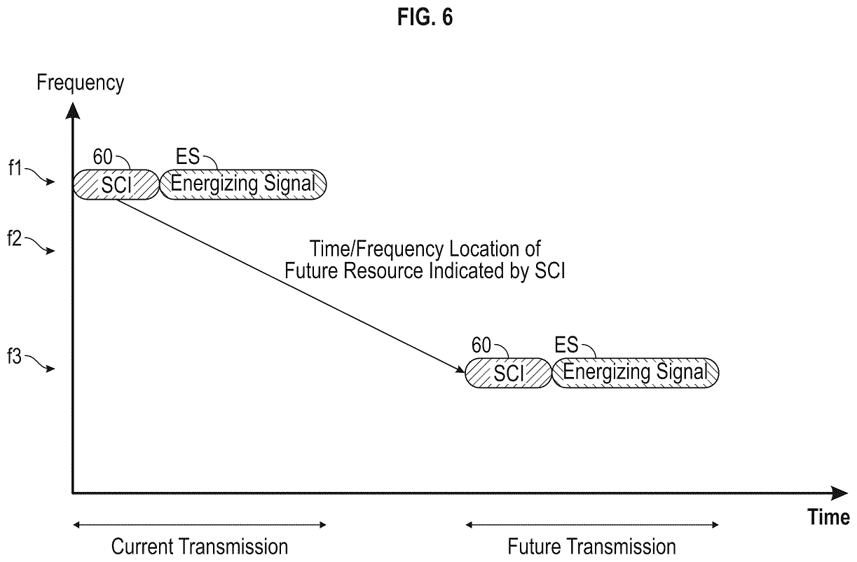

FIG. 6 is a diagram depicting a method for scheduling the energizing signal ES, according to some embodiments of the present disclosure.

Referring to FIG. 6, in some embodiments, resources of the energizing signal ES may be reserved by SCI. For example, the energizing signal ES may be accompanied by sidelink control information (SCI) 60 for channel reservation. For example, the intermediate node 300 (e.g., a UE) may perform an SCI (e.g., may send SCI 60) indicating its future reservations before transmitting a reservation signal. For example, SCI 60 from a current transmission on a first channel (e.g., frequency f1) may indicate a reservation of resources on a second channel (e.g., frequency f3) for a future transmission of the energizing signal ES to neighboring UEs. The main purpose of the SCI 60 may be to indicate the future resources that are selected to be occupied by the intermediate node 300 (e.g., a UE) for transmitting the energizing signal ES. In some embodiments, the contents of the SCI 60 may include an indication of the future time and/or frequency resources (e.g., time resource indicator value/frequency resource indicator value (TRIV/FRIV)), the duration of the reservation, and the periodicity and priority of the transmission.

In some embodiments, when the source of the energizing signal ES is a UE and the source of the corresponding coded payload (e.g., the coded signal CS) is the base station 110 (e.g., a gNB), the resources for transmission of the energizing signal ES may be scheduled by a DCI.

FIG. 7 is a diagram depicting synchronization using a preamble PR and a coded signal CS in the presence of a relatively contiguous energizing signal ES, the preamble PR preceding the slot of the coded signal CS, according to some embodiments of the present disclosure.

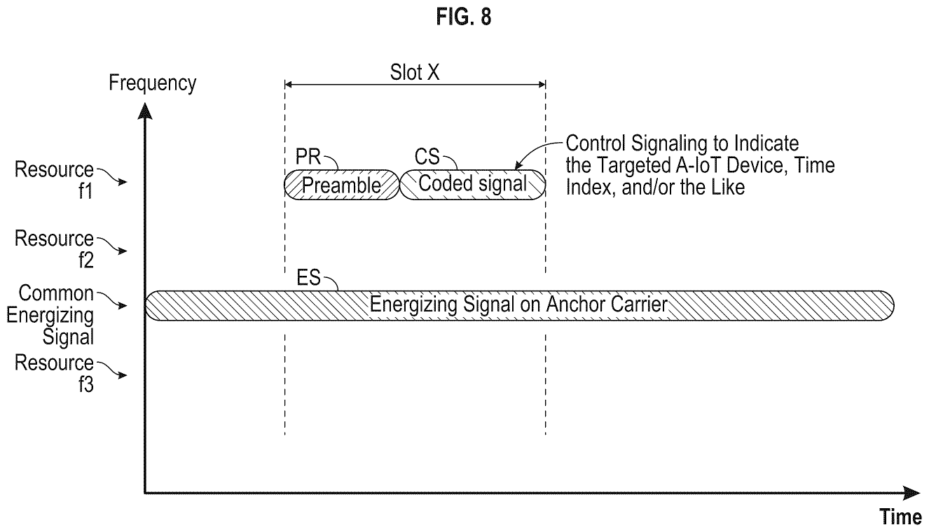

FIG. 8 is a diagram depicting synchronization using a preamble PR and a coded signal CS in the presence of a relatively contiguous energizing signal ES, the preamble PR being provided in the same slot as the coded signal CS, according to some embodiments of the present disclosure.

Referring to FIG. 7, in some embodiments, a different approach may be used to activate and synchronize the A-IoT devices 200. For example, the energizing signal ES may be either (i) effectively always present or (ii) present for extended durations to activate the A-IoT devices 200. In such embodiments, unlike the previous approaches, the transmission of the energizing signal ES may be uncorrelated (e.g., completely uncorrelated) with the transmission of the coded payload (e.g., the coded signal CS). For example, the source may elect to always transmit an energizing signal ES on either a selected or a pre-configured resource. The energizing signal ES, in such embodiments, may be detected by neighboring A-IoT devices 200 (e.g., neighboring devices of Type 1 and/or Type 2a) and, accordingly, the neighboring A-IoT devices 200 may harvest the energy and become active. Subsequently, these A-IoT devices 200 may then attempt to detect (e.g., to blindly detect) the coded signal CS to achieve synchronization and subsequently to perform data transmissions/receptions. Because the correlation, in such embodiments, may not be provided through the energizing signal ES, the preamble PR (e.g., a synchronization preamble) may be utilized before the transmission of the coded signal CS to ensure that the A-IoT devices 200 may correctly detect the initial point of the transmission. For example, in some embodiments, the preamble PR may be sent in a physical reader-to-device channel (PRDCH) transmission before the coded signal CS to indicate the beginning of the coded signal CS. In some embodiments, the transmission of the preamble PR may be either optional or it may be based on pre-configuration. In some embodiments, the A-IoT device 200 may decode at least a portion of a payload based on the preamble PR. For example, the payload may include the coded signal CS indicated by the preamble PR, and the A-IoT device 200 may determine the portion of the payload to decode based on the preamble PR indicating the beginning of the coded signal CS.

As used herein, the “preamble” refers to a bit pattern (e.g., a bit sequence) having, at least, a portion that indicates the beginning of a payload (e.g., of the coded signal CS). For example, the preamble PR may include a sequence of 1s and 0s (e.g., a specific sequence of 1s and 0s) indicating the beginning of the coded signal CS to the A-IoT device 200. In some embodiments, the preamble PR may include a pseudo-noise (PN) sequence. In some embodiments, the preamble PR may include (e.g., may be associated with) a constant portion (e.g., a sequence of 1s followed by 0101 or a sequence of 0s followed by 1010). In some embodiments, a portion of the preamble PR may cause the A-IoT device 200 to wake up (e.g., to become activated). In some embodiments, the A-IoT device 200 may receive the preamble PR indicating a slot number, of the coded signal CS, which includes control signaling for the targeted A-IoT device 200. In some embodiments, the control signaling of the coded signal CS may include a time index to indicate the current slot for synchronization purposes. In some embodiments, the control signaling of the coded signal CS may be followed by data. For example, the data may include instructions for performing an operation by equipment to which a given A-IoT device 200 is attached. The preamble may be used to synchronize one or more A-IoT devices 200 with (e.g., within) a timing scheme for performing a transmission of a signal, performing a reception of a signal, and/or performing an action based on a received signal. In some embodiments, the A-IoT device 200 may determine a slot for responding to the payload, based on the preamble PR. For example, the A-IoT device 200 may obtain synchronization information (e.g., including current slot information) from the preamble PR and may select a future slot that is a number of slots away from the current slot based on the synchronization information of the preamble PR.

In some embodiments, the preamble PR may be used by the A-IoT device 200 for synchronization and to detect the location of the associated coded signal CS.

In some embodiments, the preamble PR may be sent before the slot carrying the control signal (e.g., the control signal of the coded signal CS) as depicted in FIG. 7. In some embodiments, both the preamble PR and the control signal CS may be sent in the same slot, as depicted in FIG. 8. In some embodiments, the coded signal CS and the preamble PR may span one or more slots (e.g., to allow the carrying of additional payload or to reduce the processing burden on the A-IoT devices 200).

In some embodiments, the preamble PR can also be sent on a different resource from the resource used to send the coded signal CS (e.g., the preamble may be sent on frequency f1 and the coded signal CS may be sent on frequency f2).

In some embodiments, the preamble PR may be sent by a different source (e.g., the base station 110) from the one sending the coded signal (e.g., the intermediate node 300). In some embodiments, the preamble PR may be as simple as a pure sine wave (e.g., an unmodulated sine wave). In some embodiments, the preamble PR may include a sequence, such as a Zadoff-Chu (ZC) sequence, an M-sequence, a gold sequence, a PN sequence or the like and may be either configured (e.g., pre-configured) per resource pool or selected (e.g., randomly selected or selected based on a procedure) by the source from a set of configured (e.g., pre-configured) preambles PR. In some embodiments, where the preamble PR is pre-configured, the sequence may be used to identify the source (e.g., a given base station 110 may be restricted to use a set of preambles PR that are different from a set of preambles PR used by a given intermediate node 300). For example, in some embodiments, the preamble PR may be pre-configured, such that a source of the signal including the preamble PR is identifiable based on, at least, a portion of the preamble. In some embodiments, the preamble PR may be predefined, such that the preamble PR does not identify a particular source of the signal including the preamble PR and matches one or more other preambles PR from one or more other sources. After detecting the preamble PR, the A-IoT device 200 may be able to identify the location of the coded signal CS and accordingly may attempt to decode the coded signal CS. The coded signal may provide additional information (e.g., a subframe index, a slot index, a time division duplexing (TDD) configuration, one or more targeted device IDs, device category, and/or the like). In some embodiments, the coded signal CS may also be fragmented in multiple segments to reduce the processing burden on the A-IoT devices 200 and save power. For example, in some embodiments, a first segment may include the targeted device ID or device category, and, accordingly, the A-IoT device 200 may discard the remaining segment if the ID or category does not match. Subsequently, the A-IoT device 200 may switch to an energy harvesting mode and wait for a following (e.g., a subsequent) control signal.

In some embodiments, low complexity A-IoT devices (e.g., Type 1 and/or Type 2a) may be configured to detect only a few segments (e.g., only one segment), whereas the more advanced devices (e.g., Type 2a and/or Type 2b) may be configured to detect a complete payload. In some embodiments, the first and second segments may be independently encoded within the payload.

In some embodiments, a duration of energy detection may be determined by configuration (e.g., by pre-configuration) based on a minimum duration between any consecutive coded signals CS and a number of repetitions, which may be configured (e.g., may be pre-configured) per resource pool. In some embodiments, the A-IoT device 200 may remain active after detecting the preamble PR and, because the A-IoT device 200 was already able to identify a slot boundary, the A-IoT device 200 may discard the detection of the following preambles PR and may focus only on the detection of the coded signal CS. In some embodiments, the duration over which the A-IoT device 200 may skip the subsequent preambles PR may be provided in a number of slots and may be configured (e.g., pre-configured) per resource pool. The duration may depend on multiple factors including the type of the A-IoT device 200, the priority of the A-IoT device 200, and the capabilities of the A-IoT device 200.

In summary, in some embodiments, the energizing signal ES may be contiguously transmitted (e.g., continuously transmitted) by the source (e.g., the base station 110 or the intermediate node 300) to energize and activate the A-IoT devices 200. In some embodiments, the energizing signal ES may be sent independently from the control signal (e.g., from the control signal of the coded signal CS). In some embodiments, the preamble PR may be added to the beginning of the control signal (e.g., the beginning of the coded signal CS) for synchronization and to identify the boundary of the control signal (e.g., the boundary of the coded signal CS). In some embodiments, the preamble PR may be as simple as a pure sine wave or it may be a more complex sequence (e.g., a PN sequence) and may be used to identify the source. In some embodiments, the preamble PR and the coded signal CS may span one or more slots to increase the payload and reduce the processing burden (e.g., to reduce a number of processing operations) at the A-IoT devices 200. In some embodiments, the coded signal CS may be divided into multiple segments to reduce the processing burden (e.g., to reduce a number of processing operations) at the A-IoT devices 200. In some embodiments, a given A-IoT device 200 may detect fewer than all of the segments (e.g., only a first segment) of a given coded signal CS. The first segment of the payload may be independently encoded from a remaining part (e.g., from remaining segments) of the payload. In some embodiments, the first segment may include the targeted devices (e.g., the targeted A-IoT devices 200) by either using a device type or a device ID.

In some embodiments, the coded signal CS may include one or more of the following three segments. In some embodiments, the coded signal CS may include a coded-signal preamble (e.g., a separate preamble from the preamble that precedes the coded signal in some embodiments). In some embodiments, the coded-signal preamble may be a short sine wave signal or a sequence (e.g., a PN sequence or a ZC sequence) to indicate the beginning of the transmission or the slot boundary. In some embodiments, the coded signal CS may include a synchronization segment. For example, the synchronization segment may be targeted mainly towards allowing the A-IoT device 200 to correctly synchronize to other devices (e.g., other A-IoT devices 200) within the system 1. In some embodiments, the synchronization segment may include contents that are similar to the contents of a PSBCH. For example, in some embodiments, the synchronization segment may include a slot index, a subframe index, a frame index, a TDD configuration, and/or the like. In some embodiments, the coded signal CS may include a control segment. In some embodiments, the control segment may be targeted towards providing control information (e.g., a set of control information) to the A-IoT device 200.

In some embodiments, the control information may include resource allocation information. The resource allocation information may provide details of the time/frequency resources that may be used by the responding A-IoT device 200 when performing its transmission. The resource allocation information may be specific to the A-IoT device 200 or may include a set of resources to be used by a group of A-IoT devices 200 (e.g., to be used for scheduling a group of A-IoT devices 200). In such embodiments, to avoid collisions, the transmissions of the A-IoT device 200 may be separated based on multiple factors (e.g., based on device ID of the A-IoT device 200).

In some embodiments, the control information may include triggering information to trigger a subset of A-IoT devices 200. The triggering information may include the ID of one or more A-IoT devices 200 or A-IoT device types. In some embodiments, the triggering information may allow the source (e.g., a gNB or a UE) to trigger only a subset of the neighboring A-IoT devices 200. In some embodiments, the triggering information may include a flag to indicate that one or more (e.g., all) neighboring A-IoT devices 200 are expected to respond and perform a synchronization.

In some embodiments, the control information may include delay information indicating a delay before a transmission. For example, the delay information may be used to separate the transmissions of multiple neighboring A-IoT devices 200 in time to avoid collisions between their transmissions to enable the correct decoding at the destination (e.g., at the gNB or at the UE).

In some embodiments, the control information may include a power control signal. The power control signal may set an upper bound on the transmit power for one A-IoT device 200 or a subset of the A-IoT devices 200. For example, the power control signal may help resolve a near-far problem (e.g., a hearability problem) by controlling the transmit power of the far away devices (e.g., far await A-IoT devices 200), such that the received power is comparable to the received power of other A-IoT devices 200.

In some embodiments, the control information may include a target transmission range signal. The target transmission range signal may include the location of the source, as well as the targeted transmission range of the A-IoT devices 200. In some embodiments, the target transmission range signal may be based on power control in the sense that the source may provide a path-loss threshold or received signal-strength threshold. In such embodiments, the A-IoT device 200 may be triggered to respond only if its measured signal strength is above the measured threshold. In some embodiments, to reduce the signaling overhead, the threshold may be signaled as an index from a configured (e.g., a pre-configured) set per resource pool.

In some embodiments, the base station 110 may schedule associated physical uplink control channel (PUCCH) resources for ACK/NACK feedback from an assigned intermediate node 300 (e.g., a UE) that is to transmit the energizing signal ES.

In some embodiments, the resources used to transmit the energizing signal ES may be independently selected by a neighboring UE through an energy detection approach (e.g., an energy detection method) or a sensing and reservation approach (e.g., a sensing and reservation method).

In some embodiments, the contents of the SCI used to reserve the resources for the energizing signal ES may include one or more of the following: a TRIV/FRIV, a reservation duration, a periodicity, and/or a priority.

In some embodiments, the contents of the coded signal CS may include one or more of the following: a synchronization segment, a control segment, and/or a data segment.

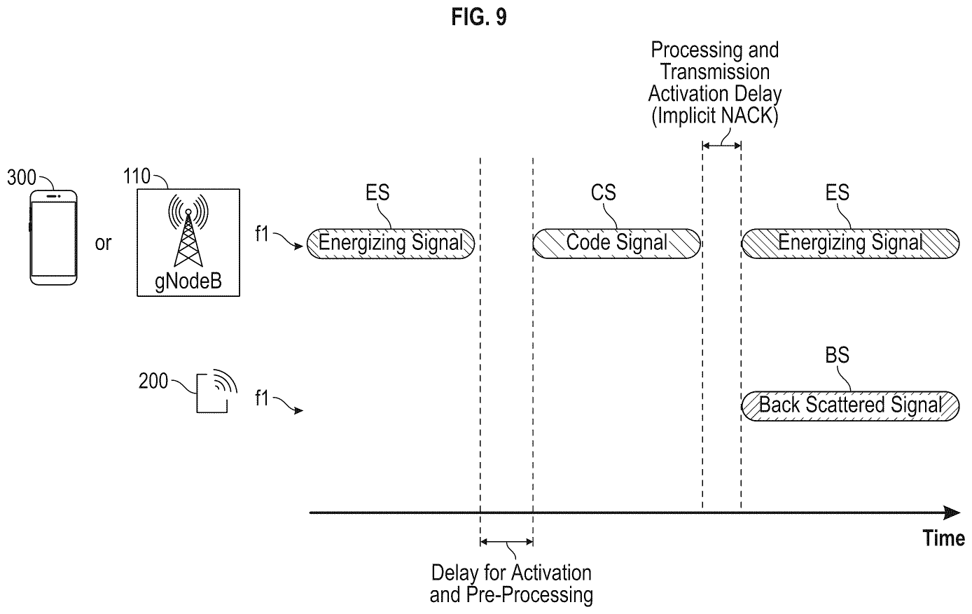

FIG. 9 is diagram depicting a multiplexing between the energizing signal ES and the coded signal CS, according to some embodiments of the present disclosure.

Referring to FIG. 9, in some embodiments, the energizing signal ES may be time multiplexed with the corresponding coded signal CS carrying the payload. In such embodiments, the energizing signal ES may be sent by the source (e.g., the base station 110 or the intermediate node 300), followed by the coded signal CS in the time domain. In some embodiments, a delay may be provided between the energizing signal ES and the coded signal CS to allow for activation and processing at the A-IoT device 200. In some embodiments, the energizing signal ES and the coded signal CS may be provided back-to-back without any delays. In such embodiments, more energy may be acquired by a given A-IoT device 200 if it is capable of activation and performing energy harvesting simultaneously. For example, the gap between the energizing signal ES and the coded signal CS may be filled by the energizing signal ES if the A-IoT device 200 is capable of energy harvesting while decoding. For devices of Type 1 and Type 2a, the transmissions may be based on backscattering and thus the energizing signal ES may be resent (e.g., may be sent again) after the coded payload is transmitted to allow the A-IoT device 200 to perform backscattering. In some embodiments, a delay may be provided between the coded signal CS and the energizing signal ES to allow for processing at the A-IoT device 200. In some embodiments, the coded signal CS and the energizing signal ES may be provided back-to-back without any delays, depending on the capability of the A-IoT device 200.

In some embodiments, the durations of the energizing signal ES and the coded signal CS may be configured (e.g., pre-configured) per resource pool. In some embodiments, the durations of the energizing signal ES and the coded signal CS may depend on multiple factors, such as the priority of the transmissions and the device type. In some embodiments, wherein the source (e.g., a UE) of the energizing signal ES is different from the source of the coded signal (e.g., a gNB), synchronization (e.g., tight synchronization) may be provided to avoid overlapping between the transmitted signals. In such embodiments, a UE may be allowed to transmit the energizing signal ES only if the UE is synchronized to the gNB. In some embodiments (e.g., when the UE and the A-IoT device 200 are far apart), tighter synchronization constraints may be applied in the sense that only UEs directly synchronized to the gNB may be allowed to send the synchronization signals. In some embodiments, the resources over which the energizing signal ES is transmitted may be either scheduled by the gNB (e.g., through a DCI) or may be directly selected by the UE through either energy detection or sensing and resource selection as discussed above.

In some embodiments, the energizing signal ES may be time multiplexed with the coded signal CS, irrespective of their sources.

In some embodiments, depending on the capability of the A-IoT device 200, a gap may be inserted between the energizing signal ES and the coded signal CS. In some embodiments, the gap may be completely occupied by the energizing signal ES.

In some embodiments, the durations of the energizing signal ES and the coded signals CS may be configured (e.g., pre-configured) per resource pool.

In some embodiments, only UEs connected to the gNB may be allowed to send the synchronization signal to the neighboring A-IoT devices 200 to provide (e.g., to ensure) proper synchronization.

In some embodiments, the energizing signal ES itself may be used to carry the coded signal CS. For example, amplitude-shift keying may be used to modulate the coded signal CS on top of the energizing signal ES. In such embodiments, the following features may be implemented. In some embodiments, if the source of the energizing signal ES is a UE (e.g., acting as the intermediate node 300) and the destination, for receiving a signal from a given A-IoT device 200, is a gNB (e.g., the base station 110), the resources over which the energizing signal ES is sent may be either scheduled by the gNB or selected independently by the UE itself. In case of gNB scheduling, the DCI scheduling the UE may also include an indication of the targeted A-IoT devices 200. In some embodiments, an indication of the targeted A-IoT devices 200 may be carried in the payload associated with the DCI. For example, in some embodiments, a UE may receive two DCIs from the gNB, wherein a first DCI schedules a given DL transmission 10 that carries information for triggering the A-IoT devices 200. Examples of this information include: an ID of the A-IoT device 200; locations of the A-IoT devices 200; a target device category (e.g., Type 1, Type 2a, and/or the like); a target transmit power; a beamwidth and direction (in the case of beamforming); and a duration of the energizing signal ES. After the first DCI, in some embodiments, a second DCI may be used to schedule the resources for the transmission of the energizing signal ES. After the first DCI, in some other embodiments, the UE may perform either energy detection or sensing-based resource selection as discussed above to select the resources for transmission of the energizing signal ES, the coded signal CS, or both.

In some embodiments, the energizing signal ES may be provided with an extended duration to allow for energy harvesting. In some embodiments, the A-IoT devices 200 may harvest some energy from the energizing signal ES before being able to decode the received signal (e.g., the coded signal CS). In such cases, a portion of the received coded signal CS may be lost. To address this issue, in some embodiments, the energizing signal ES may include additional redundancy (e.g., may use very low code rate transmissions) in the signal to compensate for the lost segments.

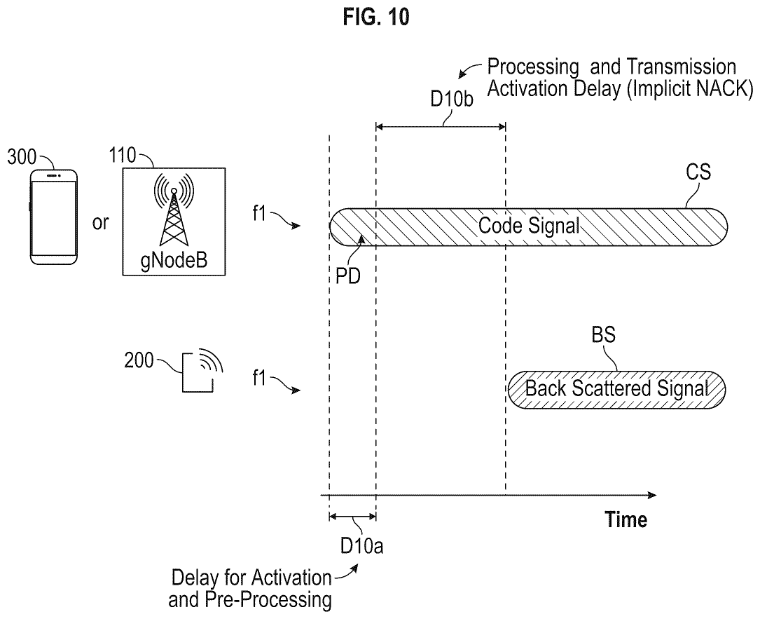

FIG. 10 is a diagram depicting padding of the coded signal CS to allow for energy harvesting, according to some embodiments of the present disclosure.

Referring to FIG. 10, in some embodiments, some portions of the coded signal CS may be padded and used only for energy harvesting. For example, in some embodiments, to allow for energy harvesting, a padded portion PD may be provided as part of a delay period (e.g., a delay D10a) for the coded signal CS for activation and pre-processing. In some embodiments, the padded portion PD may be provided before a delay period (e.g., delay D10b) for the coded signal CS for processing and transmission activation (e.g., implicit NACK). In some embodiments, the padded portion PD may be independently coded from the remaining portion of the coded signal CS.

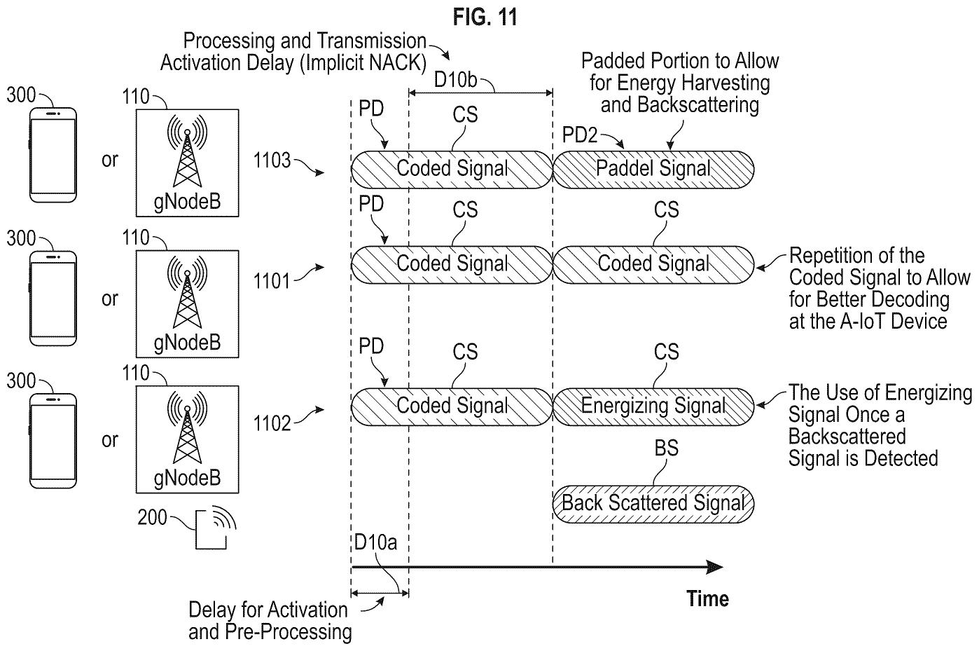

FIG. 11 is a diagram depicting three methods (e.g., three alternatives) for handling a portion the coded signal CS after the transmission of the backscattering signal BS from the A-IoT device 200, according to some embodiments of the present disclosure.

Referring to FIG. 11, in some embodiments, a similar padding approach may be implemented when the A-IoT device 200 starts to perform backscattering (e.g., starts transmitting the backscattered signal BS) because it may not be suitable to decode any information (e.g., there may be no information to decode). In such embodiments, the source (e.g., gNB or UE) may either repeat the coded signal CS in case it was not correctly decoded at the A-IoT device 200 or the source may insert padding. In some embodiments, the UE may stop transmitting the encoded signal (e.g., the coded signal CS) and switch to an energizing signal ES only once it starts to receive the backscattered signal BS from the A-IoT device 200.

The three alternative methods are depicted in FIG. 11. In some embodiments, padded portion PD (e.g., a padding portion) may be independently encoded from the remaining part of the signal (e.g., the remaining part of the coded signal CS). In some embodiments, a method 1101 may be performed by the source (e.g., a gNB or a UE) to reduce latency, wherein (after the source transmits a first instance of the control signal (e.g., of the coded signal CS)) the source sends (e.g., continues to send) another repetition of the coded signal CS in case the coded signal CS was not correctly decoded by the destination device. In some embodiments, a method 1102 may be performed by the source (e.g., a gNB or a UE), wherein (after the source transmits a first instance of the control signal (e.g., of the coded signal CS)) the source sends an energizing signal ES to provide the power for the A-IoT device 200 to continue the transmission of the backscattering signal BS. In some embodiments, a method 1103 may be performed by the source (e.g., a gNB or a UE), wherein (after the source transmits a first instance of the control signal (e.g., of the coded signal CS)) the source sends a padded signal (e.g., a second padded portion PD2) to maintain the channel reservation (e.g., in case of an unlicensed spectrum) so that the source may transmit another control signal at a later point in time (e.g., to maintain the channel occupancy) if it doesn't receive a backscattered signal from the A-IoT device 200. In some embodiments, the method 1103 may be implemented as an alternative to the method 1102, wherein if the source does not receive the backscattered signal BS from the A-IoT device 200, the source may continue to transmit the padded signal (e.g., the second padded portion PD2), instead of the energizing signal ES of the method 1102, to keep the channel reservation. In other words, in some embodiments, if a backscattered signal BS is received, the energizing signal ES may continue, and if no backscattered signal is received for a given duration, the source may send the second padded signal PD2 to maintain the channel reservation.

In some embodiments, the energizing signal ES may be modulated by the coded data to avoid transmitting another signal.

In some embodiments, the resources over which a UE sends the modulated energizing signal ES may be scheduled by the gNB through DCI.

In some embodiments, two or more DCIs may be used to schedule a UE to transmit a modulated energizing signal ES to neighboring A-IoT devices 200.

In some embodiments, a portion of the modulated energizing signal ES may be dedicated for energy harvesting or backscattering through padding or by using a lower code rate.

In some embodiments, the padded portion PD of the modulated energizing signal ES can be independently coded from the remaining portion of the energizing signal ES.

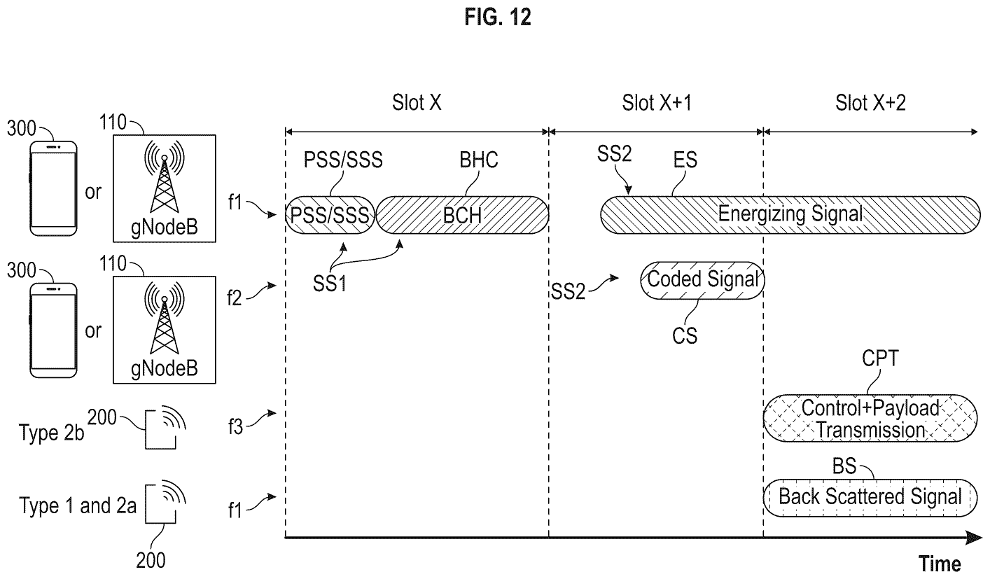

FIG. 12 is a diagram depicting a method for dividing a synchronization signal into two components to support different device categories, according to some embodiments of the present disclosure.

Referring to FIG. 12, in some embodiments, there may be some scenarios where A-IoT devices 200 from all device categories (e.g., Type 1, Type 2a, and Type 2b) are present in the system 1. While A-IoT devices 200 of Type 1 and Type 2a do not perform active transmissions and may rely on backscattering, A-IoT devices 200 of Type 2b may have a power source and, accordingly, may perform transmissions without relying on backscattering of the received signal (e.g., the received energizing signal ES). To be able to correctly decode the traffic from the three device types (e.g., Type 1, Type 2a, and Type 2b), the A-IoT devices 200 within the system 1 may be synchronized to improve the system performance and simplify the decoding process. To achieve this, in some embodiments, a mixture of the sidelink synchronization signals and the energizing signals ES discussed above may be utilized. For example, in some embodiments, the synchronization signal may include the following components: an energy signal (e.g., the energizing signal ES) to energize A-IoT devices 200 of Type 1 and Type 2a; a primary synchronization signal PSS and a secondary synchronization signal SSS for synchronization of A-IoT devices 200 of Type 2b; and/or a simplified broadcast channel BCH as may be suitable.

In some embodiments, A-IoT devices 200 of Type 1 and Type 2a may be active only once the energizing signal ES is received because these types of A-IoT devices 200 may not have an onboard power source (Type 2a devices may be active for a slightly longer duration than Type 1 devices due to the energy storing capability of the Type 2a devices). Accordingly, in some embodiments, the synchronization signal may be divided into two components, wherein a first component is used for synchronizing Type 2b devices and the second component is used to synchronize the other IoT device types (e.g., Types 1 and 2a). For example, the first component (also referred to as a first synchronization source SS1) may include the primary synchronization signal PSS, the secondary synchronization signal SSS, and/or a simplified broadcast channel BCH. The first component is depicted in FIG. 12 as corresponding to a first slot (e.g., slot X). The second component (also referred to as a second synchronization source SS2) may include the energizing signal ES and the coded signal CS. The second component is depicted as corresponding to a second slot (e.g., slot X+1) and a third slot (e.g., slot X+2). In some embodiments, Type 2b devices may transmit a control-and-payload transmission CPT after being synchronized by the first component. In other words, in some embodiments two types of synchronization sources may be used: (i) the PSS/SSS/BCH signal for Type 2b devices, which or more capable and (ii) the energizing signal ES (with the help of the coded signal CS) for synchronizing Type 1 devices and/or for synchronizing Type 2a devices. In some embodiments, the coded signal CS may allow Type 2a devices to have more time for energy harvesting. In some embodiments, Type 1 and Type 2a devices may transmit their backscattered signals BS after being activated by the energizing signal ES (e.g., at slot X+2). In some embodiments, Type 2a devices may transmit their backscattered signals BS after being activated by the energizing signal ES and after receiving the coded signal CS (e.g., at slot X+2).

In some embodiments, any two adjacent frequencies (e.g., frequency f1 and frequency f2) may be either adjacent or may be separated by a gap. For example, the gap may reduce energy leakage from one carrier to another (e.g., from frequency f1 to frequency f2). In some embodiments, devices of Type 2b may be synchronized by using the energizing signal ES with less accuracy. For example, a configured (e.g., pre-configured) reserved frequency may be used in a resource pool for the energizing signal ES. This signal (e.g., the energizing signal ES) may then be used to activate A-IoT devices 200 of Type 1 and Type 2a, as well as to synchronize the devices of Type 2b. In such embodiments, the energizing signal ES may be transmitted at the configured (e.g., pre-configured) frequencies at specific points in time (e.g., at the slot boundary of slot 0 in each subframe) for a configured (e.g., pre-configured) duration. Subsequently, A-IoT devices 200 of Type 1 and Type 2a may automatically activate once the energizing signal ES is detected, whereas devices of Type 2b may monitor (e.g., may continuously monitor) the configured (e.g., pre-configured) frequencies for the presence of the energizing signal ES. Despite the simplicity of this approach, one issue that may arise is the impact of path loss on the harvested energy. For example, a Type 2a device that is close to the source may harvest sufficient energy in less time than another Type 2a device that is far away from the source. Subsequently, these A-IoT devices 200 may not all be able to transmit immediately at the slot boundary.

To address the issue of the A-IoT devices 200 not being able to transmit immediately at the slot boundary, the following may be considered for the three types of devices. In some embodiments, Type 1 devices may not need to harvest large amounts of energy because they may not have an energy storage. Accordingly, Type 1 devices may be reliant on the presence of the energizing signal ES for their backscattered transmissions (e.g., for transmitting the backscattered signal BS). In such embodiments, once the received energy is above a threshold for activation, the A-IoT devices 200 may start to transmit either immediately after being activated or after receiving the coded signal CS to trigger their backscattering (e.g., once their IDs are detected). In some embodiments, if the A-IoT devices 200 are reliant only on the presence of the energizing signal ES, then their transmission can be included (e.g., contained) within the slot boundary by adjusting the duration of the energizing signal ES. In some embodiments, on the other hand, if the A-IoT devices 200 rely on the decoding of the coded signal CS, then the decoded signal may be transmitted at a later point in time to ensure that the backscattering starts at the slot boundary.

In some embodiments, Type 2a devices may have energy storage and, thus, Type 2a devices may have energy storage and may use more time to accumulate enough energy. This duration for accumulating enough energy may depend on the received signal strength (e.g., the strength of the energizing signal ES). Accordingly, in some embodiments, to ensure that Type 2a devices start to transmit only at the slot boundary, Type 2a devices may be confined to transmit only after receiving the coded signal CS. The coded signal CS may then be transmitted only at the slot boundary for proper alignment of the A-IoT-device transmissions.

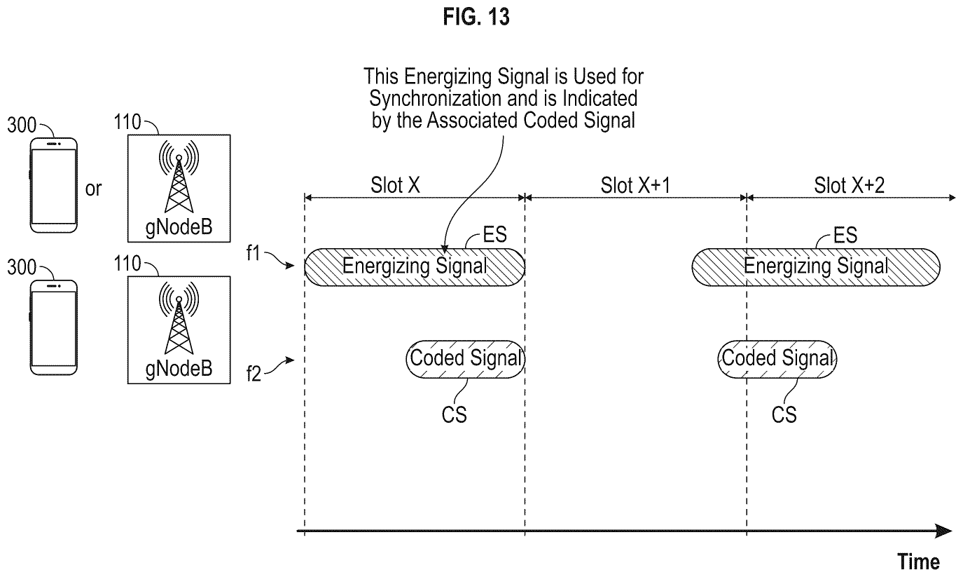

FIG. 13 is a diagram depicting energizing signals starting at a slot boundary (as indicated by associated coded signals), which may be used for synchronization, according to some embodiments of the present disclosure.

Referring to FIG. 13, in some embodiments, Type 2b devices may have their own energy source (e.g., an on-board energy source). Accordingly, in some embodiments, Type 2b devices may monitor the configured (e.g., pre-configured) resource for the presence of the energizing signal ES. Subsequently, the design of the energizing signal ES may be adjusted to ensure that the Type 2b devices can detect the slot boundary. For example, in some embodiments, the design of the energizing signal ES may be as depicted in FIG. 13, wherein the energizing signal ES is used for synchronization and is indicated by the associated (e.g., a corresponding) coded signal CS. In FIG. 13, some instances of the energizing signals ES may start and end only at the slot boundary. In some embodiments, these instances of the energizing signals ES may be used for slot alignment and may be indicated by the accompanying coded signal CS.

In some embodiments, a synchronization signal for a system that supports all (e.g., all three) A-IoT device types may include (e.g., may consist of) the following components: the energy signal ES and coded signal CS to energize and synchronize A-IoT devices 200 of Type 1 and of Type 2a; PSS and SSS for synchronization of A-IoT devices 200 of Type 2b; and/or a simplified broadcast channel (BCH) as may be suitable.

In some embodiments, a simplified approach may be used to synchronize the Type 2b devices by relying on an energizing signal ES that is sent at a configured (e.g., pre-configured) frequency.

In some embodiments, some instances of the energizing signal ES may be designed to start at the slot boundary and may be used by Type 2b devices for alignment. These instances may be indicated by the associated coded signal CS.

In some embodiments, repetitions of the synchronization signal may be provided to improve the reliability of the synchronization signal detection. For example, the synchronization signal (e.g., which may also include or be the energizing signal ES in some embodiments) may have multiple repetitions in the frequency domain to provide frequency diversity. In some embodiments, the synchronization signal (or the energizing signal ES) may be repeated by several sources (e.g., by the gNB and by the UE simultaneously). In some embodiments, the number of the repetitions, the frequency location of the first repetition, and the separation between consecutive repetitions may be configured (e.g., pre-configured) per resource pool. The frequency domain repetitions may help in the following situations (e.g., scenarios).

In some embodiments, the frequency domain repetitions (also referred to as “frequency repetitions” or “repetitions”) may be detected by A-IoT devices 200 with limited detection bandwidth. For example, operating on a limited (e.g., a very limited) bandwidth may help reduce the complexity of the A-IoT devices 200 and may conserve energy. However, the A-IoT devices 200 operating in these bandwidths may suffer from deep fades thus limiting their ability to have (e.g., to achieve) proper synchronization, as well as limiting their ability to perform energy harvesting. As used herein, a deep fade refers to a type of interference, which may result in a high path loss that deteriorates the signal quality and may result in a temporary failure of communication due to the high path loss. In some embodiments, a given A-IoT device 200 may alternate among (e.g., may hop between) different frequencies when attempting to detect the synchronization signals. For example, in some embodiments, the A-IoT device 200 may select a second signal based on a signal strength of a first signal being less than a threshold value, the second signal may include a signal to synchronize the A-IoT device. In some embodiments, the A-IoT device 200 may harvest energy from one or more repetitions simultaneously. Such embodiments may be helpful when multiple sources simultaneously transmit the synchronization signal.

In some embodiments, the frequency repetitions may help with frequency multiplexing of multiple Type 1 devices because such devices may rely on the received energizing signal ES for backscattering (e.g., for transmitting the backscattered signal BS). In some embodiments, each device or a subset of devices may monitor a different synchronization (or energizing signal ES) on a different bandwidth for synchronization and transmission triggering.

In some embodiments, the frequency repetitions may help increase the available power for harvesting. To achieve this, in some embodiments, the synchronization signal (or the energizing signal ES) may be sent by different sources simultaneously. For example, in some embodiments, multiple neighboring UEs (e.g., acting as intermediate nodes 300) may be designated by the base station 110 (e.g., a gNB) to transmit the synchronization signals (or the energizing signals ES) along with the synchronization signals (or the energizing signals ES) transmitted by the base station 110. Subsequently, the A-IoT devices 200 of Type 2a may harvest the energy received from all the signals, allowing the A-IoT devices 200 to reduce their charging time. In such embodiments, the A-IoT devices 200 may benefit from the presence of a neighboring UE because a neighboring UE may provide a relatively high signal strength (e.g., compared to a UE or gNB that is relatively far away).

In some embodiments, a number of frequency domain repetitions may be configured (e.g., pre-configured) per resource pool and may be dependent on (e.g., may be determined based on) the supported A-IoT device categories. For example, in some embodiments, if the resource pool allows transmissions from only Type 1 devices, then the number of repetitions may be configured (e.g., pre-configured) to X, whereas when Type 2a devices are supported, the number of repetitions may be configured (e.g., pre-configured) to Y (X and Y being integers that are different from each other). In some embodiments, the repetitions in the frequency domain of the synchronization signal (or energizing signal ES) may be divided into two subcategories. The first category may be identified as the anchor synchronization signal and may be sent by the base station 110 (e.g., a gNB) whereas the other repetitions may be considered as non-anchored transmissions and may be sent by the neighboring UEs (e.g., acting as intermediate nodes 300) in the system. The power levels of the anchor and non-anchor transmissions may be configured (e.g., pre-configured) separately. For example, in some embodiments, the synchronization signal (or the energizing signal ES) sent on the anchor frequency might be allowed to have a higher transmission power threshold. In some embodiments, the transmission on the anchor frequency may be distinguishable either by configuration (e.g., pre-configuration) or by the accompanying coded signal CS. For example, in some embodiments, a specific configured (e.g., pre-configured) frequency may be used for transmitting the anchor synchronization signal. In some embodiments, the payload in the coded signal CS may be used to either directly (through a dedicated field) or indirectly (be setting one or more fields to pre-defined values) indicate whether this transmission (e.g., whether the present transmission) is an anchor transmission or not.

In some embodiments, because the anchor synchronization signal may be sent by the base station 110 (e.g., a gNB), the anchor synchronization signal may be expected to have the highest quality when compared to the synchronization signals sent by the neighboring UEs. Accordingly, in some embodiments, when a given A-IoT device 200 attempts to synchronize, it may first attempt to synchronize to the anchor synchronization signal (e.g., may select the anchor signal for synchronization first), and then may attempt to synchronize to the non-anchor signals (e.g., may select from among one or more non-anchor signals for synchronization). This approach may be similar to the synchronization procedure of NR sidelink transmissions in which NR UEs may attempt to synchronize to a gNB or to a global navigation satellite system (GNSS) before attempting to synchronize to a neighboring synchronization reference UE. In some embodiments, the A-IoT device 200 may select a second signal (e.g., a non-anchor synchronization signal or frequency) for synchronization based on a signal strength of a first signal (e.g., an anchor synchronization signal or frequency) being (e.g., becoming) less than a threshold value. In some embodiments, when a preamble PR is utilized for synchronization, the non-anchor synchronization signals and anchor synchronization signals may include the same preamble PR. In some embodiments, the A-IoT device 200 may be able to differentiate between the anchor and non-anchor signals based on the coded signal CS or based on the frequencies used to carry the anchor or non-anchor signals.

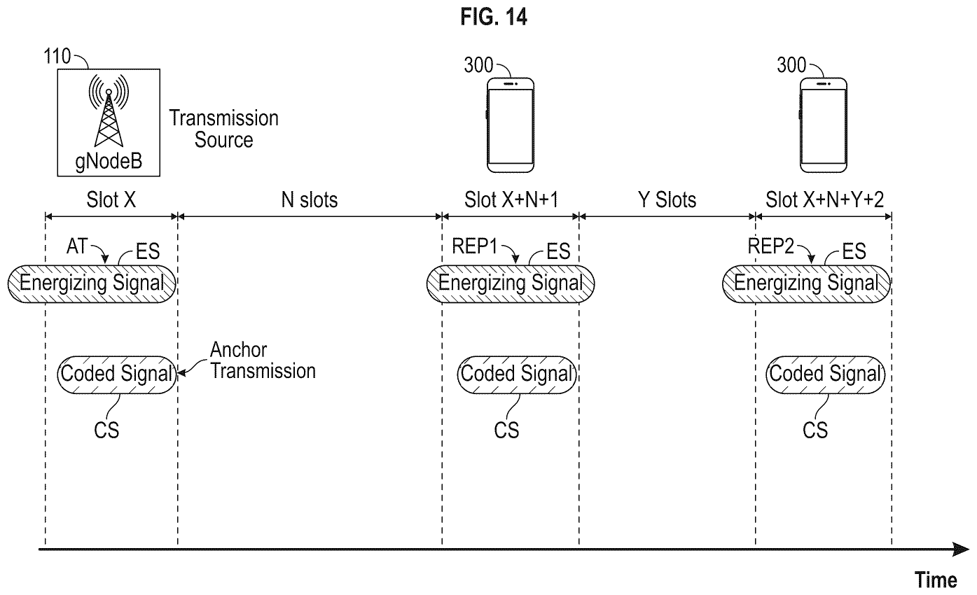

FIG. 14 is a diagram depicting time-domain repetitions of the energizing signal ES, according to some embodiments of the present disclosure.

Referring to FIG. 14, in some embodiments, and similar to the frequency domain repetitions discussed above, the synchronization signal (which may include or be the energizing signal ES in some embodiments) may be repeated in the time domain. For example, in some embodiments, an anchor synchronization signal may be transmitted at a given time instance (as an anchor transmission AT) followed by one or more repetitions (e.g., REP1 and REP2). In some embodiments, the number of these repetitions and the separation between consecutive repetitions and the separation between the anchor transmission and the repetitions may be configured (e.g., pre-configured) per resource pool. In some embodiments, the anchor synchronization signal transmission (e.g., the anchor transmission AT) may be allowed to have a higher power than the non-anchor transmissions. In some embodiments, the transmission of the anchor synchronization signal (e.g., the anchor transmission AT) may be limited to the gNB only, whereas the repetitions (e.g., REP1 and/or REP2) may be either done by the gNB or neighboring UEs. In some embodiments, the transmission on the anchor (e.g., the anchor transmission AT) may be distinguishable by the accompanying coded signal CS. In other words, the payload in the coded signal CS may be used to either directly (through a dedicated field) or indirectly (by setting one or more fields to defined (e.g., pre-defined values) may indicate whether this transmission (e.g., the corresponding energizing signal ES) is an anchor transmission AT or not.

In some embodiments, a given energizing signal ES may include a first energizing signal corresponding to a group of repetitions of energizing signals repeated in the time domain or in the frequency domain. For example, the group of repetitions may include the first energizing signal and a second energizing signal that is separated from the first energizing signal in time or by frequency.

In some embodiments, to improve the detection reliability of the synchronization signal, the synchronization signal may be repeated in the frequency domain by one or more sources simultaneously.

In some embodiments, the number of frequency domain repetitions and the separation between consecutive repetitions may be configured (e.g., pre-configured) per resource pool.

In some embodiments, the frequency domain repetitions of the synchronization signal may be divided into two categories (e.g., anchor and non-anchor transmissions), wherein some categories may be sent only by the gNB.

In some embodiments, the transmission of the anchored synchronization signal (also referred to as an anchored energizing signal ES) may be done on a configured (e.g., a pre-configured) frequency and may have a higher transmit power. For example, in some embodiments, the energizing signal ES may correspond to a group of repetitions of energizing signals repeated in the frequency domain, and the energizing signal ES may be pre-configured, by a source, to be transmitted on an anchor frequency to provide energy to the A-IoT device 200.

wherein the In some embodiments, when performing synchronization, an A-IoT device 200 may be expected to favor the anchored synchronization signal over non-anchored ones. For example, in some embodiments, the A-IoT device 200 may determine whether the anchored synchronization signal is suitable and use the anchored synchronization signal before non-anchored synchronization signals if the anchored synchronization signal is suitable.

In some embodiments, the synchronization signal may have multiple repetitions in the time domain, wherein the number of these repetitions and the separation between them can be configured (e.g., pre-configured) per resource pool.

In some embodiments, the synchronization signal (or energizing signal ES) may be time multiplexed and/or frequency multiplexed from a first-source signal and a second-source signal. For example, the synchronization signal (or energizing signal ES) from a first source (e.g., a gNB or a UE) may be multiplexed with the synchronization signal (or energizing signal ES) from a second source (e.g., a gNB or a UE). In some embodiments, the multiplexing may be triggered by the gNB through DCI signaling (e.g., when the resources over which the energizing signal ES is sent are obtained through the DCI from the gNB). In some embodiments, the multiplexing may be triggered by the UEs performing sensing and sending SCI to reserve future resources. For example, a given UE performing sensing may send SCI to reserve a future resource for the given UE's energizing signal ES. The multiplexing itself may be performed in the sense that the energizing signal ES may be sent by multiple sources on resources that are either separated in time or frequency (e.g., on resources that are time multiplexed or on resources that are frequency multiplexed). Multiplexing may be performed to reduce latency or to reduce interference. For example, in some embodiments using frequency multiplexing, multiple neighboring sources may send their energizing signals ES simultaneously on different frequencies, thus, reducing the latency. In some embodiments using time multiplexing, the latency may increase, while the overall system interference may be decreased and less resources may be consumed. The benefits of multiplexing may include either increasing the number of A-IoT devices 200 that can simultaneously respond to their corresponding readers (e.g., corresponding sources) at a given time (e.g., a given time instant) or reducing the consumed resources and improving the reliability of a given A-IoT device's back scattered transmission (e.g., the backscattered signal BS) to (e.g., with respect to) its corresponding source by reducing interference when time multiplexing is used. In some embodiments, when frequency multiplexing is used a first source and a second source may use different frequencies when transmitting their energizing signals ES to given A-IoT devices 200.

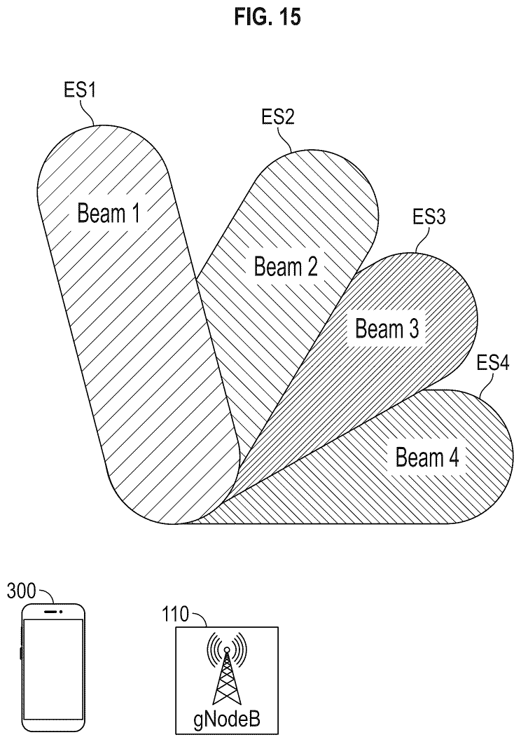

FIG. 15 is a diagram depicting beamforming of synchronization signals, according to some embodiments of the present disclosure.

Referring to FIG. 15, in some embodiments, when transmitting the synchronization/energizing signal ES, beam forming may be performed. For example, the synchronization/energizing signal ES may be pointed in different directions at different times, by the source (e.g., a gNB or a UE), to ensure enough power can be harvested by the Type 1 and Type 2a devices. For example, the source may form: a first beam ES1 in a first direction; a second beam ES2 in a second direction; a third beam ES3 in a third direction; and/or a fourth beam ES4 in a fourth direction, and so on (through an n-th beam). To realize the gains from this beamforming, the following aspects may be considered (e.g., may be implemented). In some embodiments, one or more beams may be formed by a given source (e.g., a base station 110 or an intermediate node 300), wherein the narrower the beam, the greater the antenna gain and, thus, beamforming may be helpful in improving the signal strength. In some embodiments, a narrow beam may be formed to allow the synchronization source to activate a lower number of A-IoT devices 200 with a higher power. However, if the beam is too narrow, higher latency may result because the synchronization source may take a longer time to sweep all the directions. Accordingly, in some embodiments, a value of the beam width may be configurable. In some embodiments, multiple values may be configured (e.g., pre-configured), wherein the beam width value may be selected based on the channel occupancy (e.g., based on the number of responding A-IoT devices 200 per sweep).

In some embodiments, the beam width may be dependent on one or more of the following factors: the transmission priority of the A-IoT devices 200; the number of successful or failed previous transmissions in a given reference duration (this duration may be based on the instance in which the UE is triggered through the energizing signal ES); the available bandwidth; the synchronization source type (e.g., gNB or a UE); the underlying topology (e.g., a topology with multiple intermediate nodes 300 (e.g., intermediate receiving nodes) may have a larger bandwidth); and the number of responding A-IoT devices 200.

In some embodiments, the strength of the energizing signal may be determined based on a given scenario. For example, in some embodiments, to manage the number of synchronized A-IoT devices 200, the source (e.g., the gNB or the UE) may control the transmit power of the synchronization signal. The higher the transmit power of the synchronization signal, the larger its coverage and, thus, the larger the number of A-IoT devices 200 that may be expected to be synchronized. Accordingly, in some embodiments, the selection of the transmit power may depend on (e.g., may be determined based on) multiple factors as follows. In some embodiments, the selection of the transmit power may depend on the messages previously received from nearby A-IoT devices 200 and their measured signal strength being above one or more configured (e.g., pre-configured) thresholds. In some embodiments, the selection of the transmit power may depend on the priority of the neighboring A-IoT devices 200 being above a configured (e.g., a pre-configured) threshold. For example, in some embodiments, if the priority of the A-IoT-device transmission is high, then the transmission may be triggered by the synchronization signal irrespective of the location of the A-IoT device 200. In some embodiments, the selection of the transmit power may depend on the locations of the A-IoT devices 200. For example, in some embodiments, selecting transmit power based on the locations of the A-IoT devices 200 may be beneficial if the locations of the A-IoT devices 200 are fixed and known at the source. In such embodiments, the source may select the transmit power level based on the selected A-IoT devices 200 to activate. In some embodiments, the selection of the transmit power may depend on the minimum duration per beam sweep. For example, selecting the transmit power based on minimum duration per beam sweep may ensure that enough power can be harvested by the neighboring A-IoT devices 200. This duration may be configured (e.g., pre-configured) based on the supported device types.

In some embodiments, beam forming may be applied on the synchronization signal to have better control of the synchronization of the neighboring A-IoT devices 200.

In some embodiments, the beam width of the transmitted synchronization signal may be configured (e.g., pre-configured) depending on one or more of the following: the transmission priority of the A-IoT devices 200; the number of successful or failed previous transmissions in a given reference duration; the available bandwidth; the synchronization source type; or the underlying topology.

In some embodiments, the strength of the synchronization signals may be configured (e.g., pre-configured) to ensure the proper synchronization of the neighboring A-IoT devices 200. This configuration may be dependent on multiple factors including the priority of the neighboring A-IoT devices 200.

In some embodiments, a minimum duration per beam sweep may be configured (e.g., pre-configured) to ensure proper activation of the neighboring A-IoT devices 200.

FIG. 16 is a block diagram of a first type of A-IoT device 200 for performing operations associated with the method for performing A-IoT based communications, according to some embodiments of the present disclosure.

Referring to FIG. 16, in some embodiments, the system 1 (see FIGS. 1, 3A, and 3B) may include one or more A-IoT devices 200 of Type 1 (also referred to as Type 1 devices or Device 1). As used herein, Type 1 refers to the Type 1 device designation used by the 3GPP. The A-IoT devices 200 of Type 1 may include one or more of the following components. In some embodiments, a given A-IoT device 200 may include: an antenna 1602; a matching network 1604 (e.g., an impedance matching network); a radio frequency (RF) energy harvester 1606; a power management unit (PMU) 1608; an energy storage 1610 (e.g., a circuit including one or more capacitors for storing electrical energy); an RF band pass filter (RF BPF) 1612; an RF envelope detector 1613; a low pass filter (LPF) 1614 (e.g., a baseband (BB) LPF); a comparator 1616; BB logics 1618 (e.g., a logic circuit); a decoder 1620; a controller 1622; an encoder 1624; a memory 1626; a clock generator 1628; and/or a backscatter modulator 1630 (e.g., a circuit for performing impedance switching). In some embodiments, the memory 1626 may store instructions, which, based on being executed by the processor, may cause the processor to perform operations disclosed herein as being performed by the A-IoT devices 200. In some embodiments, the backscatter modulator 1630 may assist in switching an impedance at the antenna 1602 to reflect the backscattered signal BS discussed above. For example, the impedance at the antenna 1602 may be matched to the impedance of a received signal to absorb the signal (e.g., as opposed to reflecting the signal). The impedance at the antenna 1602 may be mis-matched (e.g., unmatched) with the impedance of the received signal to reflect the signal (e.g., as opposed to absorbing the signal). In some embodiments, the receiver (also referred to as a “reader”) of the backscattered signal BS may interpret a portion of the backscattered signal BS absorbed by the A-IoT device 200 as a first binary value (e.g., a 1 or a 0) and may interpret a portion of the backscattered signal BS reflected by the A-IoT device 200 as a second binary value (e.g., a 0 or a 1) that is the opposite value of the first binary value.

A-IoT devices 200 of Type 2a (a 3GPP designation) may be similar to A-IoT devices 200 of Type 1 discussed above, with the ability to store more energy, for example, at the energy storage 1610 and to perform energy amplification on the reflected/received signals.

FIG. 17 is a block diagram of a second type of A-IoT device 200 for performing operations associated with the method for performing A-IoT based communications, according to some embodiments of the present disclosure.

Referring to FIG. 17, in some embodiments, the system 1 may include one or more A-IoT devices 200 of Type 2a (also referred to as Type 2a devices or Device 2b). As used herein, Type 2b refers to the Type 2b device designation used by the 3GPP. The A-IoT devices 200 of Type 2b may include one or more of the following components. In some embodiments, a given A-IoT device 200 may include: an antenna 1702; a matching network 1704 (e.g., an impedance matching network); an RF energy harvester 1706; a PMU 1708; an energy storage 1710 (e.g., a circuit including one or more capacitors for storing electrical energy); an RF BPF 1712; an RF envelope detector 1713; a LPF 1714 (e.g., a BB LPF); a comparator/N-bit analog-to-digital converter (ADC) 1716; BB logics 1718 (e.g., a processor); a decoder 1720; a controller 1722; an encoder 1724; a memory 1726; a clock generator 1728; a power amplifier 1731; an energy harvester 1732 (for other than RF energy); a low-noise amplifier (LNA) 1734; a BB amp 1738; a transmission circuit 1740; a transmission modulator 1742; a digital-to-analog converter (DAC) 1744; a low-pass filter 1746; a mixer 1748 (e.g., a mixer including a local oscillator LO, including a phased-locked loop oscillator or a frequency-locked loop oscillator). In some embodiments, the memory 1726 may store instructions, which, based on being executed by the processor, may cause the processor to perform operations disclosed herein as being performed by the A-IoT devices 200.

In some embodiments, a Type 2b device may also include components for sending backscattered signals BS, as discussed above (e.g., with respect to the backscatter modulator 1630).

FIG. 18 is a block diagram of an electronic device (e.g., a user equipment (UE)) in a network environment 1800, according to some embodiments of the present disclosure.

Referring to FIG. 18, an electronic device 1801 in a network environment 1800 may communicate with an electronic device 1802 via a first network 1898 (e.g., a short-range wireless communication network), or an electronic device 1804 or a server 1808 via a second network 1899 (e.g., a long-range wireless communication network). The electronic device 1801 may communicate with the electronic device 1804 via the server 1808. The electronic device 1801 may include a processor 1820, a memory 1830, an input device 1850, a sound output device 1855, a display device 1860, an audio module 1870, a sensor module 1876, an interface 1877, a haptic module 1879, a camera module 1880, a power management module 1888, a battery 1889, a communication module 1890, a subscriber identification module (SIM) card 1896, or an antenna module 1897. In one embodiment, at least one (e.g., the display device 1860 or the camera module 1880) of the components may be omitted from the electronic device 1801, or one or more other components may be added to the electronic device 1801. Some of the components may be implemented as a single integrated circuit (IC). For example, the sensor module 1876 (e.g., a fingerprint sensor, an iris sensor, or an illuminance sensor) may be embedded in the display device 1860 (e.g., a display).

The processor 1820 may execute software (e.g., a program 1840) to control at least one other component (e.g., a hardware or a software component) of the electronic device 1801 coupled with the processor 1820 and may perform various data processing or computations.

As at least part of the data processing or computations, the processor 1820 may load a command or data received from another component (e.g., the sensor module 1876 or the communication module 1890) in volatile memory 1832, process the command or the data stored in the volatile memory 1832, and store resulting data in non-volatile memory 1834. The processor 1820 may include a main processor 1821 (e.g., a central processing unit (CPU) or an application processor (AP)), and an auxiliary processor 1823 (e.g., a graphics processing unit (GPU), an image signal processor (ISP), a sensor hub processor, or a communication processor (CP)) that is operable independently from, or in conjunction with, the main processor 1821. Additionally or alternatively, the auxiliary processor 1823 may be adapted to consume less power than the main processor 1821, or execute a particular function. The auxiliary processor 1823 may be implemented as being separate from, or a part of, the main processor 1821.

The auxiliary processor 1823 may control at least some of the functions or states related to at least one component (e.g., the display device 1860, the sensor module 1876, or the communication module 1890) among the components of the electronic device 1801, instead of the main processor 1821 while the main processor 1821 is in an inactive (e.g., sleep) state, or together with the main processor 1821 while the main processor 1821 is in an active state (e.g., executing an application). The auxiliary processor 1823 (e.g., an image signal processor or a communication processor) may be implemented as part of another component (e.g., the camera module 1880 or the communication module 1890) functionally related to the auxiliary processor 1823.

The memory 1830 may store various data used by at least one component (e.g., the processor 1820 or the sensor module 1876) of the electronic device 1801. The various data may include, for example, software (e.g., the program 1840) and input data or output data for a command related thereto. The memory 1830 may include the volatile memory 1832 or the non-volatile memory 1834. Non-volatile memory 1834 may include internal memory 1836 and/or external memory 1838.

The program 1840 may be stored in the memory 1830 as software, and may include, for example, an operating system (OS) 1842, middleware 1844, or an application 1846.

The input device 1850 may receive a command or data to be used by another component (e.g., the processor 1820) of the electronic device 1801, from the outside (e.g., a user) of the electronic device 1801. The input device 1850 may include, for example, a microphone, a mouse, or a keyboard.

The sound output device 1855 may output sound signals to the outside of the electronic device 1801. The sound output device 1855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1860 may visually provide information to the outside (e.g., a user) of the electronic device 1801. The display device 1860 may include, for example, a display, a hologram device, or a projector and control circuitry to control a corresponding one of the display, hologram device, and projector. The display device 1860 may include touch circuitry adapted to detect a touch, or sensor circuitry (e.g., a pressure sensor) adapted to measure the intensity of force incurred by the touch.

The audio module 1870 may convert a sound into an electrical signal and vice versa. The audio module 1870 may obtain the sound via the input device 1850 or output the sound via the sound output device 1855 or a headphone of an external electronic device 1802 directly (e.g., wired) or wirelessly coupled with the electronic device 1801.

The sensor module 1876 may detect an operational state (e.g., power or temperature) of the electronic device 1801 or an environmental state (e.g., a state of a user) external to the electronic device 1801, and then generate an electrical signal or data value corresponding to the detected state. The sensor module 1876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1877 may support one or more specified protocols to be used for the electronic device 1801 to be coupled with the external electronic device 1802 directly (e.g., wired) or wirelessly. The interface 1877 may include, for example, a high-definition multimedia interface (HDMI), a universal serial bus (USB) interface, a secure digital (SD) card interface, or an audio interface.

A connecting terminal 1878 may include a connector via which the electronic device 1801 may be physically connected with the external electronic device 1802. The connecting terminal 1878 may include, for example, an HDMI connector, a USB connector, an SD card connector, or an audio connector (e.g., a headphone connector).

The haptic module 1879 may convert an electrical signal into a mechanical stimulus (e.g., a vibration or a movement) or an electrical stimulus which may be recognized by a user via tactile sensation or kinesthetic sensation. The haptic module 1879 may include, for example, a motor, a piezoelectric element, or an electrical stimulator.

The camera module 1880 may capture a still image or moving images. The camera module 1880 may include one or more lenses, image sensors, image signal processors, or flashes. The power management module 1888 may manage power supplied to the electronic device 1801. The power management module 1888 may be implemented as at least part of, for example, a power management integrated circuit (PMIC).

The battery 1889 may supply power to at least one component of the electronic device 1801. The battery 1889 may include, for example, a primary cell which is not rechargeable, a secondary cell which is rechargeable, or a fuel cell.

The communication module 1890 may support establishing a direct (e.g., wired) communication channel or a wireless communication channel between the electronic device 1801 and the external electronic device (e.g., the electronic device 1802, the electronic device 1804, or the server 1808) and performing communication via the established communication channel. The communication module 1890 may include one or more communication processors that are operable independently from the processor 1820 (e.g., the AP) and supports a direct (e.g., wired) communication or a wireless communication. The communication module 1890 may include a wireless communication module 1892 (e.g., a cellular communication module, a short-range wireless communication module, or a global navigation satellite system (GNSS) communication module) or a wired communication module 1894 (e.g., a local area network (LAN) communication module or a power line communication (PLC) module). A corresponding one of these communication modules may communicate with the external electronic device via the first network 1898 (e.g., a short-range communication network, such as BLUETOOTH™, wireless-fidelity (Wi-Fi) direct, or a standard of the Infrared Data Association (IrDA)) or the second network 1899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1892 may identify and authenticate the electronic device 1801 in a communication network, such as the first network 1898 or the second network 1899, using subscriber information (e.g., international mobile subscriber identity (IMSI)) stored in the subscriber identification module 1896.

The antenna module 1897 may transmit or receive a signal or power to or from the outside (e.g., the external electronic device) of the electronic device 1801. The antenna module 1897 may include one or more antennas, and, therefrom, at least one antenna appropriate for a communication scheme used in the communication network, such as the first network 1898 or the second network 1899, may be selected, for example, by the communication module 1890 (e.g., the wireless communication module 1892). The signal or the power may then be transmitted or received between the communication module 1890 and the external electronic device via the selected at least one antenna.

Commands or data may be transmitted or received between the electronic device 1801 and the external electronic device 1804 via the server 1808 coupled with the second network 1899. Each of the electronic devices 1802 and 1804 may be a device of a same type as, or a different type, from the electronic device 1801. All or some of operations to be executed at the electronic device 1801 may be executed at one or more of the external electronic devices 1802, 1804, or 1808. For example, if the electronic device 1801 should perform a function or a service automatically, or in response to a request from a user or another device, the electronic device 1801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1801. The electronic device 1801 may provide the outcome, with or without further processing of the outcome, as at least part of a reply to the request. To that end, a cloud computing, distributed computing, or client-server computing technology may be used, for example.

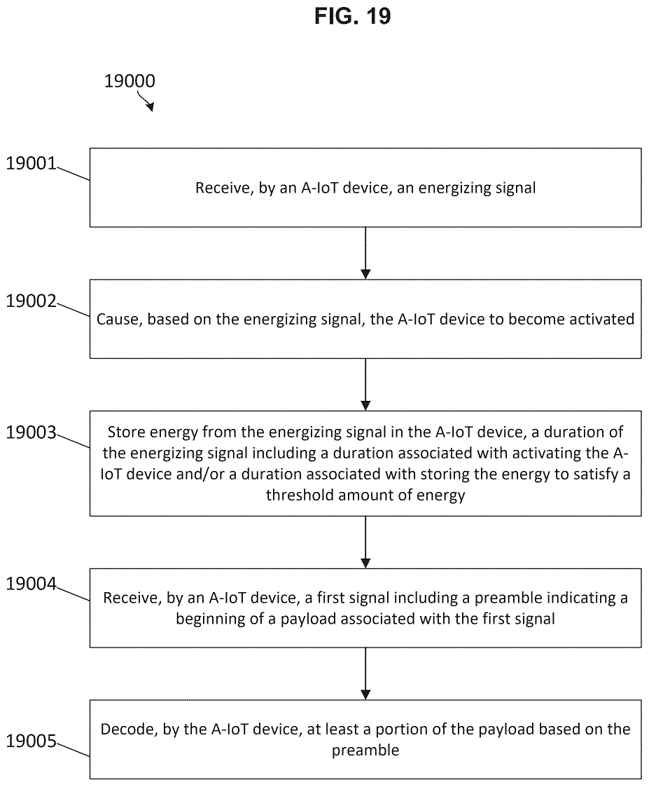

FIG. 19 is a flowchart depicting example operations of a method 19000 for performing A-IoT based communications, according to some embodiments of the present disclosure.

The method 1900 may include one or more of the following operations. The A-IoT device may receive an energizing signal ES (operation 19001). The energizing signal ES may cause the A-IoT device 200 to become activated (e.g., to wake up) (operation 19002). The A-IoT device 200 may store energy from the energizing signal ES (operation 19003). A duration of the energizing signal ES may include a duration associated with activating the A-IoT device 200 and/or a duration associated with storing the energy to satisfy a threshold amount of energy (e.g., to be equal to or greater than the threshold amount of energy for performing an operation by the A-IoT device 200). The A-IoT device 200 may receive a first signal, including a preamble PR indicating a beginning of a payload associated with the first signal (operation 19004). The A-IoT device 200 may decode at least a portion of the payload based on the preamble PR (operation 19005).

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for performing Ambient-Internet-of-Things (A-IoT) based communications, the method comprising:
receiving, by an A-IoT device, an energizing signal;
causing, based on the energizing signal, the A-IoT device to become activated;
storing energy from the energizing signal in the A-IoT device, a duration of the energizing signal comprising a duration associated with activating the A-IoT device and/or a duration associated with storing the energy to satisfy a threshold amount of energy;
receiving, by the A-IoT device, a first signal comprising a preamble, at least a portion of the preamble indicating a beginning of a payload associated with the first signal; and
decoding, by the A-IoT device, at least a portion of the payload based on the preamble.

2. The method of claim 1, wherein the preamble comprises a first bit sequence to synchronize the A-IoT device with a timing scheme for performing a transmission, a reception, and/or an action.

3. The method of claim 2, wherein the preamble is pre-configured, such that a source of the first signal is identifiable based on at least a portion of the preamble.

4. The method of claim 1, wherein the preamble comprises a sine wave to synchronize the A-IoT device with a timing scheme for performing a transmission, a reception, and/or an action.

5. The method of claim 1, wherein the preamble is received, by the A-IoT device, in a physical reader-to-device channel (PRDCH) to indicate the beginning of a coded signal.

6. The method of claim 1, wherein a portion of the preamble is pre-defined and causes the A-IoT device to become activated.

7. The method of claim 2, wherein the preamble is predefined, such that a first preamble from a first source comprises a same bit sequence as a second preamble from a second source.

8. The method of claim 1, wherein a resource of the energizing signal is scheduled by a base station through a DCI, or
wherein the resource of the energizing signal is reserved by SCI based on UE sensing.

9. The method of claim 1, wherein the energizing signal is time multiplexed and/or frequency multiplexed from a first-source signal and a second-source signal.

10. The method of claim 1, wherein the first signal comprises the energizing signal.

11. The method of claim 1, wherein the energizing signal is a first energizing signal corresponding to a group of repetitions of energizing signals repeated in a time domain or in a frequency domain, and
wherein the group of repetitions comprises the first energizing signal and a second energizing signal that is separated from the first energizing signal by a duration of time or by corresponding to a different frequency than the first energizing signa.

12. The method of claim 11, wherein the first energizing signal corresponds to the group of repetitions of energizing signals repeated in the frequency domain, and
wherein the first energizing signal is pre-configured, by a source, to be transmitted on an anchor frequency to provide energy to the A-IoT device.

13. The method of claim 1, wherein the A-IoT device selects a second signal based on a signal strength of the first signal being less than a threshold value, the second signal comprising a signal to synchronize the A-IoT device.

14. The method of claim 1, further comprising detecting, by the A-IoT device, only a first segment of the payload, the first segment being independently encoded from a remaining part of the payload.

15. A device comprising:
a processor; and
an antenna communicatively connected to the processor, wherein:
the antenna is configured to:
receive an energizing signal and a first signal, the first signal comprising a preamble, at least a portion of the preamble indicating a beginning of a payload associated with the first signal; and
cause energy from the energizing signal to be stored in the device, a duration of the energizing signal comprising a duration associated with activating the processor and/or a duration associated with storing the energy to satisfy a threshold amount of energy; and
the processor is configured to decode at least a portion of the payload based on the preamble.

16. The device of claim 15, wherein the preamble comprises a first bit sequence to synchronize the device with a timing scheme for performing a transmission, a reception, and/or an action.

17. The device of claim 16, wherein the preamble is pre-configured, such that a source of the first signal is identifiable based on at least a portion of the preamble.

18. The device of claim 15, wherein the preamble comprises a sine wave to synchronize the device with a timing scheme for performing a transmission, a reception, and/or an action.

19. The device of claim 15, wherein the preamble is received, by the antenna, in a physical reader-to-device channel (PRDCH) to indicate the beginning of a coded signal.

20. A system comprising:
a processor; and
a memory storing instructions, which, based on being executed by the processor, cause the processor to perform:
becoming activated based on energy from an energizing signal, a duration of the energizing signal comprising a duration associated with activating the system and/or a duration associated with storing, by the system, the energy to satisfy a threshold amount of energy;
receiving a first signal comprising a preamble, at least a portion of the preamble indicating a beginning of a payload associated with the first signal; and
decoding at least a portion of the payload based on the preamble.
